(19) United States
(12) Patent Application Publication
(10) Pub. No.: US 2006/0061751 A1
(43) Pub. Date: Mar. 23, 2006

(54) Stage assembly including a stage having increased vertical stroke

(76) Inventors: Ting-Chien Teng, Fremont, CA (US); Bausan Yuan, San Jose, CA (US)

Correspondence Address: The Law Office of Steven G. Roeder, 5560 Chelsea Avenue, La Jolla, CA, 92037, US

(21) Appl. No.: 10/945,638

(22) Filed: Sep. 21, 2004

(51) Int. Cl. G03B 27/58

(52) U.S. Cl. 355/72; 355/75

(57) ABSTRACT

A stage assembly (220) includes a stage base (202) having a guide surface (203), a first stage (206), a second stage (208), and a first mover subassembly (216) including a first mover (231) and a second mover (232) that are arranged in series. The stage base (202) supports the first stage (206), which moves relative to the stage base (202). The movers (231, 232) cooperate to move the second stage (208) relative to the first stage (206). The movers (231, 232) can include one or more attraction-only type actuators. The movers (231, 232) cooperate to move the second stage (208) along an axis that is substantially perpendicular to the guide surface (203). The stage assembly (220) can also include a second mover subassembly (216) that cooperates with the first mover subassembly (216) to move the second stage (208) with two or more degrees of freedom relative to the first stage (206). Further, the first mover (231) can directly move a portion of the second mover (232).

### FIELD OF THE INVENTION

The present invention relates generally to a precision apparatus including a stage assembly having a stage capable of increased vertical movement.

### BACKGROUND

Precision assemblies such as exposure apparatuses are commonly used to transfer images from a reticle onto a semiconductor wafer during semiconductor processing. A typical exposure apparatus includes an illumination source, a reticle stage assembly that retains a reticle, an optical assembly, a wafer stage assembly that retains a semiconductor wafer, a measurement system, and a control system.

In one embodiment, the wafer stage assembly includes a wafer stage that retains the wafer, and a wafer mover assembly that precisely positions the wafer stage and the wafer. Somewhat similarly, the reticle stage assembly includes a reticle stage that retains the reticle, and a reticle mover assembly that precisely positions the reticle stage and the reticle.

The size of the images and features within the images transferred onto the wafer from the reticle are extremely small. Accordingly, the precise positioning of the wafer and the reticle relative to the optical assembly is critical to the manufacture of high density, semiconductor wafers. Recently, one or more E/I core type actuators have been used in the wafer stage assembly and/or the reticle stage assembly. E/I core type actuators can include a somewhat “E”shaped electromagnet and an “I”shaped target that is spaced apart a relatively small gap from the electromagnet. Each electromagnet has an electrical coil wound around the center section. Current directed through the coil creates an electromagnetic field that attracts the target toward the electromagnet, effectively decreasing the gap between the electromagnet and the target. Although the amount of current is an important factor in determining the force of attraction, a larger gap between the electromagnet and the target requires a greater amount of current to generate the same attractive force. Additionally, a greater amount of current typically results in more heat being generated during actuation.

The force generated by each E/I core actuator can be used to move a device along and/or about an X axis, a Y axis and/or a Z axis. For example, in an exposure apparatus, the control system can direct current to the electromagnets to control the position of a stage.

Unfortunately, the stroke of the E/I core actuator can be limited. One attempt to increase the travel of the E/I core actuator includes enlarging the gap between the electromagnet and the target. However, the enlarged gap requires a greater level of current, which typically results in an increase in heat of the system. Further, an enlarged gap can require a significant increase in power consumption, i.e. a reduction in the force per amp efficiency of the stage assembly.

In light of the above, there is a need for a stage assembly for a precision assembly, including a stage having an increased vertical stroke component about the X axis, about the Y axis and/or along the Z axis that does not significantly cause an increase in heat or excessive power consumption.

### SUMMARY

The present invention is directed to a stage assembly that includes a first stage, a second stage that supports a device, and a mover assembly that moves the second stage relative to the first stage. The first stage supports the second stage. In one embodiment, the mover assembly includes a support mover and a first mover component that is coupled to the support mover. The support mover moves the first mover component to change a distance between the first mover component and one of the stages. In one embodiment, the first mover component is part of an attraction-only type actuator that moves the second stage with one degree of freedom in a direction that is substantially toward and away from the first stage. Further, the support mover can include a mover motor and a support mover carriage. The mover motor causes at least a portion of the support mover carriage to move in a first direction, which moves the first mover component in a second direction that is different than the first direction.

In another embodiment, the stage assembly includes a stage base having a guide surface, a first stage, a second stage, and a first mover subassembly including a first mover and a second mover that are arranged in series. In this embodiment, the stage base supports the first stage. The first stage moves relative to the stage base. In one embodiment, the movers cooperate to move the second stage relative to the first stage. For example, one of the movers can include an attraction-only type actuator. In one embodiment, the movers cooperate to move the second stage along an axis that is substantially perpendicular to the guide surface. In an alternative embodiment, the movers cooperate to move the second stage with three degrees of freedom relative to the first stage. The stage assembly can also include a second mover subassembly that cooperates with the first mover subassembly to move the second stage with three degrees of freedom relative to the first stage.

Further, the first mover can directly move a portion of the second mover. In another embodiment, the first mover is secured to the first stage and the second mover is secured to the second stage. Moreover, the first mover can move the second stage relative to the second mover. The first mover can also move a portion of the second mover along an axis that is substantially perpendicular to the guide surface, and the second mover can move the second stage along an axis that is substantially perpendicular to the guide surface.

In yet another embodiment, the stage assembly includes a stage base having a guide surface, a device table that supports a device, and a first mover subassembly. The first mover subassembly can include a first mover and a second mover that are positioned in series. The movers cooperate to move the device table along an axis that is substantially perpendicular to the guide surface. With these designs, the stage assembly allows greater movement of the device table, and thus the device, along an axis that is perpendicular to the guide surface of the stage base.

The present invention is also directed to a precision assembly, a device, a wafer, and a method for positioning one or more stages of a stage assembly.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic view of a precision assembly having features of the present invention;

FIG. 2A is a perspective view of a stage assembly having features of the present invention;

FIG. 2B is a perspective view of an actuator pair having features of the present invention;

FIG. 2C is a cross-sectional view of a portion of the stage assembly taken on line 2C-2C in FIG. 2A having a second stage mover assembly in a first position;

FIG. 2D is a cross-sectional view of a portion of the stage assembly illustrated in FIG. 2A in a raised position having a second stage mover assembly in a second position;

FIG. 2E is a cross-sectional view of a portion of the stage assembly illustrated in FIG. 2A in a lowered position having a second stage mover assembly in a third position;

FIG. 2F is a block diagram that illustrates a system for controlling the stage assembly in FIG. 2A;

FIG. 3A is a cross-sectional view of another embodiment of the stage assembly including a second stage mover assembly in a first position;

FIG. 3B is a cross-sectional view of the stage assembly in FIG. 3A including a second stage mover assembly in a second position;

FIG. 3C is a cross-sectional view of the stage assembly in FIG. 3A including a second stage mover assembly in a third position;

FIG. 3D is a block diagram illustrating a system for controlling the stage assembly illustrated in FIG. 3A;

FIG. 4A is a simplified perspective view of another embodiment of the stage assembly having features of the present invention;

FIG. 4B is a simplified top view of a portion of the stage assembly illustrated in FIG. 4A;

FIG. 4C is a detailed view of a portion of the stage assembly illustrated in FIG. 4A;

FIG. 4D is a cross-sectional view of a portion of the stage assembly taken on line 4D-4D in FIG. 4C;

FIG. 4E is a cross-sectional view of another portion of the stage assembly taken on line 4E-4E in FIG. 4C;

FIG. 4F is a detailed view of a portion of the stage assembly illustrated in FIG. 4A, including a support mover in a first position;

FIG. 4G is a detailed view of a portion of the stage assembly illustrated in FIG. 4A, including a support mover in a second position;

FIG. 5 is a cross-sectional view of a portion of another embodiment of the stage assembly having features of the present invention;

FIG. 6A is a flow chart that outlines a process for manufacturing a device in accordance with the present invention; and

FIG. 6B is a flow chart that outlines device processing in more detail.

### DESCRIPTION

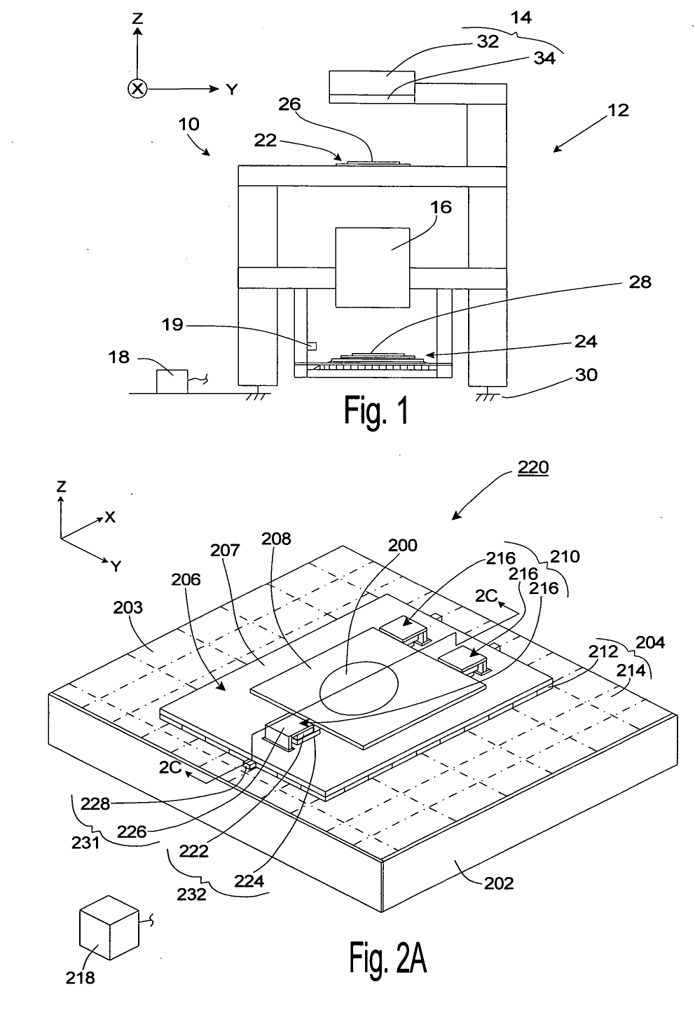

FIG. 1 is a schematic illustration of a precision assembly 10, namely an exposure apparatus, having features of the present invention. The precision assembly 10 illustrated in FIG. 1 includes an apparatus frame 12, an illumination system 14 (irradiation apparatus), an optical assembly 16, a control system 18, a measurement system 19, a reticle stage assembly 22 and a wafer stage assembly 24. The design of the components of the precision assembly 10 can be varied to suit the design requirements of the precision assembly 10.

A number of Figures include an orientation system that illustrates an X axis, a Y axis that is orthogonal to the X axis and a Z axis that is orthogonal to the X and Y axes. These axes can also be referred to as a first axis, a second axis and a third axis.

The precision assembly 10 can be particularly useful as an exposure apparatus. An exposure apparatus can be used as a lithographic device that transfers a pattern (not shown) of an integrated circuit from a reticle 26 onto a semiconductor wafer 28. The precision assembly 10 mounts to a mounting base 30, e.g., the ground, a base, or floor or some other supporting structure.

There are a number of different types of lithographic devices. For example, the precision assembly 10 can be used as scanning type photolithography system that exposes the pattern from the reticle 26 onto the wafer 28 with the reticle 26 and the wafer 28 moving synchronously. In a scanning type lithographic device, the reticle 26 is moved perpendicularly to an optical axis of the optical assembly 16 by the reticle stage assembly 24, and the wafer 28 is moved perpendicularly to the optical axis of the optical assembly 16 by the wafer stage assembly 24. Scanning of the reticle 26 and the wafer 28 occurs while the reticle 26 and the wafer 28 are moving synchronously.

Alternatively, the precision assembly 10 can be a step-and-repeat type photolithography system that exposes the reticle 26 while the reticle 26 and the wafer 28 are stationary. In the step and repeat process, the wafer 28 is in a substantially constant position relative to the reticle 26 and the optical assembly 16 during the exposure of an individual field. Subsequently, between consecutive exposure steps, the wafer 28 is consecutively moved with the wafer stage assembly 24 perpendicularly to the optical axis of the optical assembly 16 so that the next field of the wafer 28 is brought into position relative to the optical assembly 16 and the reticle 26 for exposure. Following this process, the images on the reticle 26 are sequentially exposed onto the fields of the wafer 28 so that the next field of the wafer 28 is brought into position relative to the optical assembly 16 and the reticle 26.

However, the use of the precision assembly 10 provided herein is not limited to a photolithography system for semiconductor manufacturing. The precision assembly 10, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern from a mask to a substrate with the mask located close to the substrate without the use of a lens assembly.

The apparatus frame 12 is rigid and supports the components of the precision assembly 10. The apparatus frame 12 illustrated in FIG. 1 supports the optical assembly 16 and the illumination system 14 above the mounting base 30.

The illumination system 14 includes an illumination source 32 and an illumination optical assembly 34. The illumination source 32 emits a beam (irradiation) of light energy. The illumination optical assembly 34 guides the beam of light energy from the illumination source 32 to the optical assembly 16. The beam illuminates selectively different portions of the reticle 26 and exposes the wafer 28. In FIG. 1, the illumination source 32 is illustrated as being supported above the reticle stage assembly 24. Typically, however, the illumination source 32 is secured to one of the sides of the apparatus frame 12 and the energy beam from the illumination source 32 is directed to above the reticle stage assembly 24 with the illumination optical assembly 34.

The illumination source 32 can be a g-line source (436 nm), an i-line source (365 nm), a KrF excimer laser (248 nm), an ArF excimer laser (193 nm) or a F₂ laser (157 nm). Alternatively, the illumination source 32 can generate charged particle beams such as an x-ray or an electron beam. For instance, in the case where an electron beam is used, thermionic emission type lanthanum hexaboride (LaB₆) or tantalum (Ta) can be used as a cathode for an electron gun. Furthermore, in the case where an electron beam is used, the structure could be such that either a mask is used or a pattern can be directly formed on a substrate without the use of a mask.

The optical assembly 16 projects and/or focuses the light passing through the reticle 26 to the wafer 28. Depending upon the design of the precision assembly 10, the optical assembly 16 can magnify or reduce the image illuminated on the reticle 26. The optical assembly 16 need not be limited to a reduction system. It could also be a 1× or a magnification system.

When far ultra-violet rays such as the excimer laser is used, glass materials such as quartz and fluorite that transmit far ultra-violet rays can be used in the optical assembly 16. When the F₂ type laser or x-ray is used, the optical assembly 16 can be either catadioptric or refractive (a reticle should also preferably be a reflective type), and when an electron beam is used, electron optics can consist of electron lenses and deflectors. The optical path for the electron beams should be in a vacuum.

Also, with an exposure device that employs vacuum ultra-violet radiation (VUV) of wavelength 200 nm or lower, use of the catadioptric type optical system can be considered. Examples of the catadioptric type of optical system include the disclosure Japan Patent Application Disclosure No. 8-171054 published in the Official Gazette for Laid-Open Patent Applications and its counterpart U.S. Pat. No, 5,668,672, as well as Japan Patent Application Disclosure No. 10-20195 and its counterpart U.S. Pat. No. 5,835,275. In these cases, the reflecting optical device can be a catadioptric optical system incorporating a beam splitter and concave mirror. Japan Patent Application Disclosure No. 8-334695 published in the Official Gazette for Laid-Open Patent Applications and its counterpart U.S. Pat. No. 5,689,377 as well as Japan Patent Application Disclosure No. 10-3039 and its counterpart U.S. patent application No. 873,605 (Application Date: Jun. 12, 1997) also use a reflecting-refracting type of optical system incorporating a concave mirror, etc., but without a beam splitter, and can also be employed with this invention. As far as is permitted, the disclosures in the above-mentioned U.S. patents, as well as the Japan patent applications published in the Official Gazette for Laid-Open Patent Applications are incorporated herein by reference.

The reticle stage assembly 22 holds and positions the reticle 26 relative to the optical assembly 16 and the wafer 28. Somewhat similarly, the wafer stage assembly 24 holds and positions the wafer 28 with respect to the projected image of the illuminated portions of the reticle 26. The stage assemblies 22, 24 are described in more detail below.

In photolithography systems, when linear motors (see U.S. Pat. Nos. 5,623,853 or 5,528,118) are used in a reticle stage assembly 22 or a wafer stage assembly 24, the linear motors can be either an air levitation type employing air bearings or a magnetic levitation type using Lorentz force or reactance force. Additionally, the stage can move along a guide, or it can be a guideless type of stage. As far as is permitted, the disclosures in U.S. Pat. Nos. 5,623,853 and 5,528,118 are incorporated herein by reference.

Alternatively, the reticle stage and/or the wafer stage could be driven by a planar motor. The planar motor drives the stage by an electromagnetic force generated by a magnet unit having two-dimensionally arranged magnets and an armature coil unit having two-dimensionally arranged coils in facing positions. With this type of driving system, either the magnet unit or the armature coil unit is connected to the stage and the other unit is mounted on the moving plane side of the stage.

Movement of the stages as described above generates reaction forces that can affect performance of the photolithography system. Reaction forces generated by motion of the wafer stage can be mechanically transferred to the floor (ground) by use of a frame member as described in U.S. Pat. No. 5,528,100 and published Japanese Patent Application Disclosure No. 8-136475. Additionally, reaction forces generated by motion of the reticle stage can be mechanically transferred to the floor (ground) by use of a frame member as described in U.S. Pat. No. 5,874,820 and published Japanese Patent Application Disclosure No. 8-330224. As far as is permitted, the disclosures in U.S. Pat. Nos. 5,528,100 and 5,874,820 and Japanese Patent Application Disclosure No. 8-330224 are incorporated herein by reference.

The control system 18 receives position information from the measurement system 19 and uses this position information to control one or both of the stage assemblies 22, 24 to precisely position the reticle 26 and/or the wafer 28.

The measurement system 19 can monitor the position and movement of portions of the reticle stage assembly 22, the wafer stage assembly 24, the reticle 26 and/or the wafer 28 relative to the optical assembly 16 or some other reference, as provided in greater detail below. This information is provided to the control system 18 to allow the control system to control the reticle stage assembly 22 to precisely position the reticle 26, and/or the wafer stage assembly 24 to precisely position the wafer 28. For example, the measurement system 19 can utilize multiple laser interferometers, encoders, sensors and/or other measuring devices.

A photolithography system (an exposure apparatus) according to the embodiments described herein can be built by assembling various subsystems, including each element listed in the appended claims, in such a manner that prescribed mechanical accuracy, electrical accuracy, and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems,.a total adjustment is performed to make sure that accuracy is maintained in the complete photolithography system. Additionally, it is desirable to manufacture an exposure system in a clean room where the temperature and cleanliness are controlled.

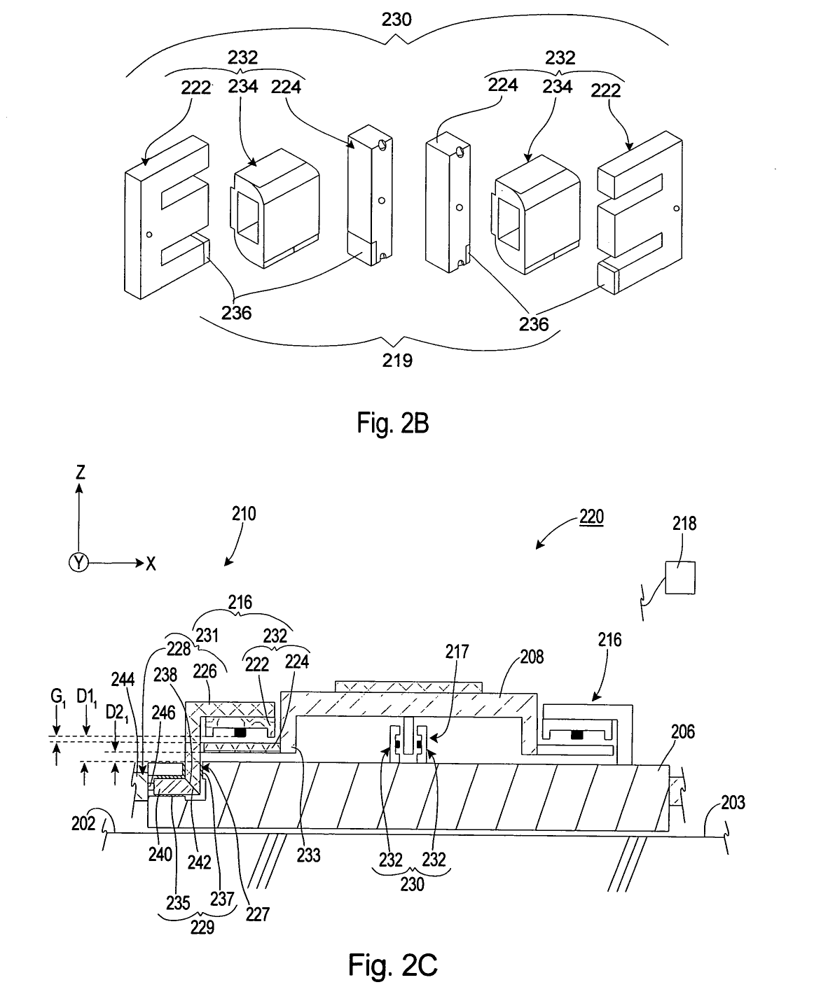

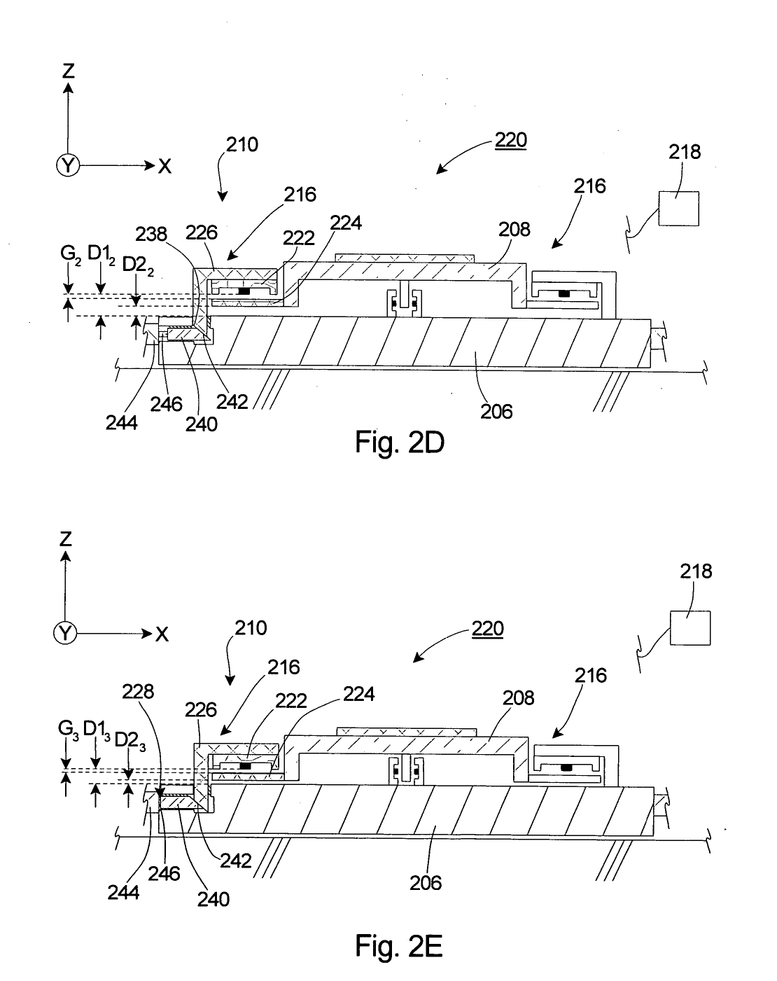

FIG. 2A is a perspective view of an embodiment of a stage assembly 220 and a control system 218, which are used to position a device 200. For example, the stage assembly 220 can be used as the wafer stage assembly 24 in the precision assembly 10 illustrated in FIG. 1. In this embodiment, the stage assembly 220 would position the device 200 (the semiconductor wafer) during manufacture of the wafer. Alternatively, the stage assembly 220 can be used to move other types of devices 200 during manufacture and/or inspection, to move a device under an electron microscope (not shown), or to move a device during a precision measurement operation (not shown). For example, the stage assembly 220 could be used as the reticle stage assembly 22. It should be noted that the control system 218 is sometimes referred to as being part of the stage assembly 220. Alternatively, the control system 218-can be a separate component from the stage assembly 220.

In the embodiment illustrated in FIG. 2A, the stage assembly 220 includes a stage base 202, a first stage mover assembly 204, a first stage 206, a second stage 208 and a second stage mover assembly 210. The design of the components of the stage assembly 220 can be varied. For example, in FIG. 2A, the stage assembly 220 includes one first stage 206 and one second stage 208. Alternatively, however, the stage assembly 220 could be designed to include greater than one first stage 206 and/or greater or fewer than one second stage 208. Moreover, in the embodiments provided herein, either stage 206, 208 can be the first stage or the second stage, as such terms are merely used herein for ease of discussion. Additionally, the stage assembly 220 illustrated in FIG. 2A is just one example of a possible stage assembly 220 that can be used in the present invention. Other suitable configurations can be used, such as a somewhat H- shaped stage assembly, as a non-exclusive example.

In FIG. 2A, the stage base 202 is generally rectangular shaped. Alternatively, the stage base 202 can be another shape. The stage base 202 supports at least some of the components of the stage assembly 220 above the mounting base 30 (illustrated in FIG. 1). The stage base 202 includes a generally flat guide surface 203 that can lie in a plane that parallel to an X-Y plane as illustrated in FIG. 2A.

The first stage 206 can be generally rectangular and plate shaped, as illustrated in FIG. 2A. However, the design of the first stage 206 can be varied to suit the design requirements of the stage assembly 220. The first stage 206 can include an upper surface 207 that generally faces the second stage 208.

The design of the first stage mover assembly 204 can be varied to suit the movement requirements of the stage assembly 220. In one embodiment, the first stage mover assembly 204 includes one or more movers, such as rotary motors, voice coil motors, linear motors utilizing a Lorentz force to generate drive force, electromagnetic actuators, planar motors, or some other force actuators.

In FIG. 2A, the first stage mover assembly 204 moves the first stage 206 relative to the stage base 202 along the X axis, along the Y axis, and/or about the Z axis (collectively “the planar degrees of freedom”). Additionally, the first stage mover assembly 204 could be designed to move and position the first stage 206 along the Z axis, about the X axis and/or about the Y axis relative to the stage base 202. Alternatively, for example, the first stage mover assembly 204 could be designed to move the first stage 206 with less than three degrees of freedom.

In the embodiment illustrated in FIG. 2A, the first stage mover assembly 204 includes a planar motor. In this embodiment, the first stage mover assembly 204 includes a first mover subassembly 212 that is secured to and moves with the first stage 206 and a second mover subassembly 214 (illustrated in phantom) that is secured to the stage base 202. The design of each mover subassembly 212, 214 can be varied. For example, one of the mover subassemblies 212, 214 can include a magnet array having a plurality of magnets and the other of the mover subassemblies 214, 212 can include a conductor array having a plurality of conductors. The size and shape of the conductor array and the magnet array and the number of conductors in the conductor array and the number of magnets in the magnet array can be varied to suit design requirements.

The first mover subassembly 212 can be maintained above the second mover subassembly 214 with vacuum pre-load type air bearings (not shown). With this design, the first stage 206 can be movable relative to the stage base 202 at least along the planar degrees of freedom. Alternatively, the first mover subassembly 212 could be supported above the second mover subassembly 214 by other ways, such as guides, a rolling type bearing, or by magnetic and/or electromagnetic levitation forces. With these designs, the first stage mover assembly 204 can be movable with up to six degrees of freedom.

The control system 218 directs electrical current to one or more of the conductors in the conductor array. The electrical current through the conductors causes the conductors to interact with the magnetic field of the magnet array. This generates a force between the magnet array and the conductor array that can be used to control, move, and position the first mover subassembly 212 and the first stage 206 relative to the second mover subassembly 214 and the stage base 202. The control system 218 adjusts and controls the current level for each conductor to achieve the desired resultant forces. Stated another way, the control system 218 directs current to the conductor array to position the first stage 206 relative to the stage base 202.

Alternatively, for example, the first stage mover assembly 204 can include other types of movers, such as a linear motor, a voice coil motor and/or electromagnetic actuators somewhat similar to the actuators utilized to move the second stage 208.

The second stage 208 includes a device holder (not shown) that retains the device 200. The device holder can include a vacuum chuck, an electrostatic chuck, or some other type of clamp.

The second stage mover assembly 210 moves and adjusts the position of the second stage 208 relative to the first stage 206. For example, the second stage mover assembly 210 can adjust the position of the second stage 208 with six degrees of freedom. Alternatively, for example, the second stage mover assembly 210 can be designed to move the second stage 208 with less than six degrees of freedom. In one embodiment, the second stage mover assembly 210 includes one or more electromagnetic actuators 232. The second stage mover assembly 210 can also include one or more rotary motors, voice coil motors, linear motors, planar motors or other type of actuators.

In the embodiment illustrated in FIG. 2A, the second stage mover assembly 210 includes three spaced apart, vertical mover subassemblies 216 that can move the second stage 208 about the X axis, about the Y axis and/or along the Z axis relative to the first stage 206, and one or more horizontal mover subassemblies 217 (one horizontal mover subassembly 217 is illustrated in FIG. 2C) that move the second stage 208 along the X axis, along the Y axis and about the Z axis relative to the first stage 206. It is recognized that a different number of vertical mover subassemblies 216 can be used than the number illustrated in FIG. 2A.

The design of each vertical mover subassembly 216 can vary. For example, as illustrated in FIG. 2A, each vertical mover subassembly 216 can include a first mover 231 and a second mover 232. In at least one embodiment, the first mover 231 and the second mover 232 are positioned in series to move the second stage 208 relative to the first stage 206 and/or the stage base 202.

At least one of the movers 231, 232 can include a first mover component 222 and a second mover component 224. In the embodiment illustrated in FIG. 2A, the second mover 232 includes the first mover component 222 and the second mover component 224.

Moreover, in the embodiment illustrated in FIG. 2A, the first mover 231 can include one or more component supports 226 and one or more support movers 228. In the embodiments described herein, the component support 226 and the support mover 228 can also be referred to herein as the first mover component and the second mover component of the first mover 231. The component supports 226 and the support movers 228 of the first mover 231 can cooperate to raise and/or lower one or more of the mover components 222, 224 relative to the other mover component of the second mover 232 along an axis that is substantially perpendicular to the guide surface 203 of the stage base. Stated another way, the first mover 231 can cooperate with the second mover 232 to move the second stage 208 in a direction that is substantially parallel to the Z axis.

In the embodiment illustrated in FIG. 2A, for each vertical mover subassembly 216, the first mover component 222 is secured to and is supported by the component support 226. Additionally, as provided herein, the support mover 228 can move the component support 226, and thus, the first mover component 222, along the Z axis relative to the first stage 206. Stated another way, the support mover 228 can move the component support 226 and the first mover component 222 toward and/or away from the first stage 206 and/or the second stage 208, and/or substantially perpendicular to the guide surface 203.

In FIG. 2A, the second mover component 224 is secured to and is supported by the second stage 208. It is recognized, however, that the either mover component 222, 224 can be the first mover component or the second mover component. Alternatively, other structures of the stage assembly 220 can support the mover components 222, 224. Additionally, one or more of the horizontal mover subassemblies 217 can have a design that is somewhat similar to the vertical mover subassemblies 216 described herein.

The control system 218 directs current to the vertical mover subassemblies 216 and/or horizontal mover subassemblies 217 to position the second stage 208 relative to the first stage 206.

FIG. 2B is an exploded perspective view of one embodiment of an actuator pair 230 that can be used for one or more of the vertical mover subassemblies 216 (illustrated in FIG. 2A) and/or one or more of the horizontal mover subassemblies 217 (illustrated in FIG. 2C). More specifically, FIG. 2B illustrates two attraction only, electromagnetic actuators 232 commonly referred to as an E/I core actuator pair. It is recognized that the vertical mover subassemblies 216 and/or the horizontal mover subassemblies 217 can utilize a single E/I core actuator instead of an actuator pair. Each E/I core actuator 232 is essentially an electromagnetic attractive device. The E/I core actuator 232 includes the first mover component 222 (also referred to herein as an “E”core), a tubular shaped conductor 234, and the second mover component 224 (also referred to herein as an “I”core). The E core 222 and the I core 224 are each made of a magnetic material such as iron, silicon steel or Ni—Fe steel. The conductor 234 is positioned around the center bar of the E core 222.

The combination of the first mover component 222 and the conductor 234 is sometimes referred to herein as an electromagnet, while the second mover component 224 is sometimes referred to herein as a target. As an example, the electromagnets can be mounted to the component support 226 (illustrated in FIG. 2A) and the targets can be secured to the second stage 208 (illustrated in FIG. 2A). In one embodiment, the second mover components 224 are attached to the second stage 208 in such a way that the attraction forces of the E/I core actuators 232 are substantially opposed by the force of gravity. With this design, the E/I core actuators 232 do not substantially distort the second stage 208.

Alternatively, the second mover components 224 can be integrally formed into the second stage 208. Moreover, the configuration of the E/I core actuators 232 can be reversed and each second mover component 224 can be the secured to a separate component support 226 and each first mover component 222 can be secured to the second stage 208. Alternatively, for example, the electromagnetic actuator can have a “C”shaped core instead of an “E”shaped core. Still alternatively, the electromagnetic actuator can have a core with a different configuration.

The control system 218 (illustrated in FIG. 2A) can control the extent of the attractive forces between the first mover component 222 and the second mover component 224 by directing more or less current to the first mover component 222. For example, for a given distance between the first mover component 222 and the second mover component 224 (also referred to herein as a “gap distance”), if a greater amount of current is directed to the first mover component 222, a greater force of attraction is generated between the first mover component 222 and the second mover component 224. On the other hand, for the same gap distance, if the level of current is decreased, the attractive force between the mover components 222, 224 is also decreased. With this design, the control system 218 can control the gap distance between the first mover component 222 and the second mover component 224.

In this embodiment, a measurement system 219 includes one or more sensors 236 that measure the gap distance between the first mover component 222 and the second mover component 224 for each electromagnetic actuator 232. The positioning of the sensors 236 and the specific location being measured can vary. A suitable sensor 236, for example, can include a capacitor sensor. However, any other appropriate sensor can be used.

Assuming the first mover component 222 remains a substantially fixed distance from the first stage 206 (illustrated in FIG. 2A), the second mover component 224 can typically have a range of movement substantially parallel to the Z axis relative to the first stage 206 (and the first mover component 222) of between approximately 0 and 500 micrometers, although this range can vary. As provided herein, the second stage mover assembly 210 allows a greater range of movement of the second stage 208 in a direction that is substantially parallel to the Z axis, and consequently about the X axis and/or about the Y axis, relative to the first stage 206.

FIG. 2C is a simplified cross-sectional view of a portion of the stage assembly 220 (the first stage mover assembly 204 has been omitted for clarity) illustrated in FIG. 2A, including the second stage mover assembly 210. The stage assembly 220 shown in FIG. 2C includes the stage base 202, the first stage 206, the second stage 208 and the second stage mover assembly 210. The second stage mover assembly 210 includes one or more horizontal mover subassemblies 217 (only one horizontal mover subassembly 217 is illustrated in FIG. 2C for clarity) and a plurality of vertical mover subassemblies 216 (two vertical mover subassemblies 216 are at least partially illustrated in FIG. 2C).

As illustrated in FIG. 2C, the first stage 206 can include one or more somewhat “L”shaped or other shaped stage apertures 229 for receiving a portion of each of the vertical mover subassemblies 216. For example, the first stage 206 can include three “L”shaped stage apertures 229. Alternatively, the first stage 206 can include greater or fewer than three “L”shaped stage apertures 229. In the embodiment illustrated in FIG. 2C, each stage aperture 229 includes a horizontal section 235 that is substantially parallel to the X axis, and a vertical section 237 that is substantially parallel to the Z axis. However, the orientation of each section 235, 237 can be varied.

In FIG. 2C, for example, the second stage 208 can be somewhat plate-shaped and/or rectangular in configuration. As illustrated in FIG. 2C, the second stage 208 also includes a flange 233 that extends downward toward the first stage 206. Additionally, for each of the vertical mover assemblies 216 illustrated in FIG. 2C, the second mover component 224 of the second mover 232 can cantilever outwardly from the flange 233.

Each horizontal mover subassembly 217 can include an actuator pair 230 comprising two electromagnetic actuators 232. Alternatively, for example, one or more of the horizontal mover subassemblies 217 can include a voice coil motor or another type of motor or actuator. Depending upon the orientation of the horizontal mover subassemblies 217, the second stage 208 can be moved along the X axis, along the Y axis and/or about the Z axis relative to the first stage 206.

Each vertical mover subassembly 216 can include an attraction-only type actuator 232. The attraction-only type actuator 232 can lift the second stage 208 relative to the first stage 206, against the force of gravity, which urges the second stage 208 down toward the first stage 206 along the Z axis. Alternatively, for example, an actuator pair 230 (illustrated in FIG. 2B) having opposed actuators 232 can be used.

Additionally, each of the vertical mover subassemblies 216 illustrated in FIG. 2C is mounted so that the attractive forces produced thereby are substantially parallel to the Z axis. With this arrangement, the vertical mover subassemblies 216 can cooperate to make fine adjustments to the position of the second stage 208 along the Z axis, about the X axis and/or about the Y axis. However, any arrangement of the vertical mover subassemblies 216 and/or horizontal mover subassemblies 217 can be used depending upon the movement and/or positioning requirements of the second stage 208.

In the embodiment illustrated in FIG. 2C, one or more of the vertical mover subassemblies 216 also includes one component support 226, one support mover 228 and one or more support guides 227. The component support 226 and the support mover 228 cooperate to move and position the first mover component 222 in a direction substantially parallel to the Z axis relative to the first stage 206. Stated another way, the component support 226 and the support mover 228 can be used to raise and/or lower one of the mover components 222, 224 relative to one of the stages 206, 208 along an axis that is substantially perpendicular to the guide surface 203 of the stage base 202.

The design of the component support 226 can vary. For example, as illustrated in FIG. 2C, the component support 226 can be substantially “L”shaped, and can be positioned at least partially within the vertical section 237 of the stage aperture 229. However any suitable configuration of the component support 226 can be used. The component support 226 supports the first mover component 222 near the second stage 208. In this embodiment, the component support 226 can include a somewhat angled wedge with a preloaded support surface 238 that interacts with the support mover 228.

The support mover 228 moves the component support 226, and thus, the first mover component 222, in a direction that is substantially parallel to the Z axis. The design of the support mover 228 can vary. For example, the support mover 228 can include one or more rotary motors, voice coil motors, linear motors utilizing a Lorentz force to generate drive force, electromagnetic actuators, planar motors, or some other force actuators. In the embodiment illustrated in FIG. 2C, the support mover 228 includes a support mover carriage 240, a support mover motor 244 and a lead screw 246. The lead screw 246 can be attached to the support mover motor 244 in order to reduce the motor force output and provide rigidity to the support mover carriage 240.

The support mover carriage 240 can have a somewhat angled, mover surface 242 that can contact the support surface 238 of the component support 226. Movement of the mover surface 242 against the support surface 238 of the component support 226 can result in vertical movement along the Z axis of the component support 226 relative to the first stage 206.

The support surface 238 can be preloaded to contact the mover surface 242. Although the support surface 238 and the mover surface 242 are illustrated in FIG. 2C on approximately 45 degree angles relative to the top surface of the first stage 206, e.g. parallel to the X-Y plane, the actual angles of each of the surfaces 238, 242 can be varied. For example, each of the surfaces 238, 242 can have an angle that can range between approximately 5 degrees and 85 degrees relative to the top surface of the first stage 206 and/or the X-Y plane. In another embodiment, each of the surfaces 238, 242 can have an angle that can range between approximately 30 degrees and 60 degrees relative to the top surface of the first stage 206 and/or the X-Y plane.

In an alternative embodiment, the sum of the angles of the support surface 238 and the mover surface 242 relative to the top surface of the first stage 206 can range between approximately 5 degrees and 175 degrees. For example, in alternative embodiments, the sum of the angles of the support surface 238 and the mover surface 242 relative to the top surface of the first stage 206 can be approximately 45 degrees, 60 degrees, 75 degrees, 90 degrees, 105 degrees, 120 degrees or 135 degrees. Still alternatively, the sum of the angles can be greater or less than the stated amounts. In yet another alternative embodiment, the sum of the angles is approximately zero degrees.

The support mover motor 244 causes the lead screw 246 to rotate, which in turn results in movement of the support mover carriage 240 substantially along the X axis. The support mover motor 244 can be secured to the first stage 206 as illustrated in FIG. 2C. The support mover 228 can include a mover damper (not shown) which can be a resilient member that reduces vibration from the support mover motor 244 that is transferred to the first stage 206 and/or other components of the stage assembly 220. Movement of the support mover carriage 240 causes a raising or a lowering of the component support 226 in a direction substantially parallel to the Z axis, resulting in movement of the first mover component 222 in a similar direction.

The support guides 227 position and support the component support 226 and the support mover 228. The support guides 227 are positioned within the stage apertures 229, and can include one or more bushings or vacuum pre-load type air bearings (not shown), as examples. With this design, the support guides 227 allow motion of the component support 226 relative to the first stage 206 substantially along the Z axis, and/or motion of the support mover carriage 240 of the support mover 228 in a direction that is substantially parallel to the X-Y plane, e.g. perpendicular to the Z axis. Alternatively, the component supports 226 and/or the support movers 228 could be supported by other ways, such as a rolling type bearing, or by magnetic and/or electromagnetic levitation forces.

The control system 218 directs current to the support mover 228 and one of the mover components 222, 224 to adjust the position of the second stage 208 along the Z axis. The current necessary to maintain a substantially constant force of attraction between the mover components 222, 224 increases significantly with an increase in distance between the mover components 222, 224. It is therefore desirable to maintain a relatively small distance between the mover components 222, 224 to decrease power consumption and the generation of excessive heat.

At a given attractive force between the first mover component 222 and the second mover component 224, the second mover component 224 is positioned a gap distance G₁ from the first mover component 222, which can generally be in the range of between approximately 0 and 500 micrometers. However, the second stage mover assembly 210 can maintain the gap distance G₁ toward the lower end of this range, thereby requiring a decreased current to the first mover component 222, resulting in lower power consumption and a decrease in the generation of heat. The electromagnet actuators 232 illustrated in FIG. 2C can be variable reluctance actuators and the reluctance can vary with the distance defined by the gap distance G₁, which in turn varies the flux and the force applied to the target.

In FIG. 2C, movement of the first mover component 222 substantially away from the first stage 206, can result in a corresponding movement of the second mover component 224, e.g. also away from the first stage 206, depending upon the amount of current being directed to the first mover component 222 by the control system 218. For example, the control system 218 can direct current to the first mover component 222 in order to maintain a substantially consistent gap distance G₁ between the first mover component 222 and the second mover component 224, as provided in greater detail below. Thus, when the first mover component 222 is raised or lowered relative to the first stage 206, the second mover component 224 also raises or lowers relative to the first stage 206. Because each of the second mover components 224 can be secured to the second stage 208 as illustrated in FIG. 2C, the second stage 208 can move in a direction substantially parallel to the Z axis in accordance with movement of the second mover components 224. Moreover, each vertical mover subassembly 216 can be independently controlled by the control system 218, which allows for disparate movements of the second mover components 224, thereby causing rotation of the second stage 208 about the X axis and/or about the Y axis.

In the embodiment illustrated in FIG. 2C, the vertical mover subassemblies 216 are shown in a first position. In the first position, the conductor of the first mover component 222 is positioned a first mover component distance D1₁ from the first stage 206. As used herein, the first position can be any position that still allows the first mover component 222 to be both raised and lowered from that position. Stated another way, the first position can be in a somewhat intermediate location of the total stroke of the first mover component 222 relative to the first stage 206 along the Z axis.

As a result of the positioning of the first mover component 222, in conjunction with the attractive force between the mover components 222, 224, the second mover component 224 is positioned a second mover component distance D2, from the first stage 206, which can vary depending upon the amount of the attractive force between the mover components 222, 224.

The second stage mover assembly 210 provided herein allows the mover components 222, 224 to remain relatively close together, without unduly limiting the stroke of the second stage 208 in a direction along the Z axis, or rotation about the X axis and/or about the Y axis. Thus, the attractive force between the mover components 222, 224 can continue to finely control the vertical positioning of the second stage 208 regardless of the distance between the second stage 208 and the first stage 206.

In FIG. 2C, for each vertical mover subassembly 216, because both the first mover component 222 and the second mover component 224 are capable of independent and/or concurrent movement toward or away from the first stage 206, a greater vertical stroke along the Z axis of the second stage 208 is achieved, without compromising finely controlled movements of the second stage 208 along the Z axis, about the X axis and/or about the Y axis. Stated another way, movement of the second mover component 224, and thus the second stage 208, is no longer limited by the stroke (i.e. up to approximately 500 micrometers) of the vertical mover subassembly 216. Instead, vertical movement of the second stage 208 is increased by the approximate vertical movement of the first mover component 222 by the support mover 228. With this design, because the gap distance G₁ can remain relatively constant, the likelihood of collision between the first mover component 222 and the second mover component 224 is reduced. Additionally, both heat and power consumption are decreased by maintaining a relatively small gap distance G₁. Further, by maintaining a smaller gap distance G₁, a higher force per amp efficiency is also maintained.

Moreover, by using two movers 231, 232 in series, one of the movers, e.g. the first mover 231, can be utilized as a coarse mover which can move the second stage 208 a relatively large vertical distance along the Z axis, while the second mover 232 can be used as a fine mover that moves the second stage 208 relatively small distances along the Z axis.

FIG. 2D is a cross-sectional view of the stage assembly 220 illustrated in FIG. 2A, including the vertical mover subassemblies 216 shown in a second position. In the second position, the support mover motor 244 has rotated the lead screw 246 so that the support mover carriage 240 has moved away from the support mover motor 244 substantially along the X-Y plane and perpendicular to the Z axis. For example, in the embodiment illustrated in FIG. 2D, the support mover carriage 240 can move substantially along the X axis. Alternatively, the second stage mover assembly 210 can include one or more support mover carriages 240 that move substantially along the Y axis, or in another direction along the X-Y plane.

In this embodiment, the second position represents an upper end of the total vertical stroke of the first mover component 222. To reach the second position, the mover surface 242 movably contacts the support surface 238, causing an upward force on the component support 226 that raises the component support 226 and the first mover component 222 relative to the first stage 206.

Each of the first mover components 222 illustrated in FIG. 2D has been moved in a direction away from the first stage 206. In one embodiment, the control system 218 can direct current to the first mover components 222 so that the second mover components 224 will substantially follow the movement of the first mover components 222. In this embodiment, the second stage 208 can move in a substantially uniform manner away from the first stage 206 along the Z axis. Alternatively, the control system 218 can direct current to the first mover components 222 to cause the second stage 208 to move non-uniformly relative to the first stage 206, which can result in rotation of the second stage 208 about the X axis and/or about the Y axis.

In the second position, the second mover component 224 can be maintained a gap distance G₂ from the first mover component 222, which can generally be in the range of between approximately 0 and 500 micrometers or greater. Stated another way, regardless of vertical movement of the first mover component 222, the second mover component 224 can be controlled by the extent of the attractive force between the mover components 222, 224. In the embodiment illustrated in FIG. 2D, for example, the gap distance G₂ when the first mover component 222 is in the second position can be substantially similar or identical to the gap distance G₁ when the first mover component 222 is in the first position, such that G₁≈G₂. However, in other embodiments, the gap distance G₂ can be varied by the control system such that G₁≠G₂.

Additionally, in the second position, the conductor of the first mover component 222 is positioned a first mover component distance D1₂ from the first stage 206, which can vary depending upon the design requirements of the second stage mover assembly 210. In the examples provided herein, D1₂>D1₁.

As a result of the positioning of the first mover component 222, in conjunction with the attractive force between the mover components 222, 224, the second mover component 224 is positioned a second mover component distance D2₂ from the first stage 206, which can vary depending upon the amount of the attractive force between the mover components 222, 224. In the example provided herein, D2₂>D2₁.

FIG. 2E is a cross-sectional view of the stage assembly 220 illustrated in FIG. 2A, including the vertical mover subassemblies 216 shown in a third position. In the third position, the support mover motor 244 has rotated the lead screw 246 so that the support mover carriage 240 has moved toward the support mover motor 244 substantially along the X-Y plane and perpendicular to the Z axis. For example, in the embodiment illustrated in FIG. 2E, the support mover carriage 240 can move substantially along the X axis. Alternatively, the second stage mover assembly 210 can include one or more support mover carriages 240 that move substantially along the Y axis, or in another direction along the X-Y plane.

As used herein, the third position represents a lower end of the total vertical stroke of the first mover component 222. To reach the third position, the mover surface 242 moves towards the support mover motor 244, allowing the force of gravity to move the component support 226 substantially downward toward the stage base along the Z axis. This movement of the component support 226 lowers the first mover component 222 relative to the first stage 206 along the Z axis.

Each of the first mover components 222 illustrated in FIG. 2E has been moved in a direction toward the first stage 206. In one embodiment, the control system 218 can direct current to the first mover components 222 so that the second mover components 224 will substantially follow the movement of the first mover components 222. In this embodiment, the second stage 208 will move in a substantially uniform manner toward the first stage 206 along the Z axis. Alternatively, the control system 218 can direct current to the first mover components 222 to cause the second stage 208 to move non-uniformly relative to the first stage 206, which can result in rotation of the second stage 208 about the X axis and/or about the Y axis. For example, one of the vertical mover subassemblies 216 can include a first mover component 222 moving toward the second position, while another vertical mover subassembly 216 can include a different first mover component 222 moving toward the third position, thereby potentially causing rotation of the second stage 208 about the X axis and/or the Y axis.

In the third position, the second mover component 224 can be maintained a gap distance G₃ from the first mover component 222, which can generally be in the range of between approximately 0 and 500 micrometers. Stated another way, regardless of vertical movement of the first mover component 222, the second mover component 224 can be controlled by the extent of the attractive force between the mover components 222, 224. In the embodiment illustrated in FIG. 2E, for example, the gap distance G₃ when the first mover component 222 is in the third position can be substantially similar or identical to the gap distance G₁ when the first mover component 222 is in the first position and/or the gap distance G₂ when the first mover component 222 is in the second position, such that G,₁≈G₃, and/or G₂≈G₃. However, in other embodiments, the gap distance G₃ can be varied by the control system 218 such that G₃≠G₁ and/or G₃≠G₂.

Additionally, in the third position, the conductor of the first mover component 222 is positioned a first mover component distance D1₃ from the first stage 206, which can vary depending upon the design requirements of the second stage mover assembly 210. In the examples provided herein, D1₃<D1₁.

As a result of the positioning of the first mover component 222, in conjunction with the attractive force between the mover components 222, 224, the second mover component 224 is positioned a second mover component distance D2₃ from the first stage 206, which can vary depending upon the amount of the attractive force between the mover components 222, 224. In the example provided herein, D2₃<D2₁.

Moreover, the support mover 228 can be used to adjust the gap distance G₁ in the event the gap distance G₁ is approaching the outer limits of the usable range of movement. For example, if the gap distance G₁ is near 500 micrometers (or any other applicable range limits), the support mover 228 can lower the component support 226, and thus the first mover component 222, toward the second mover component 224 to decrease the gap distance G₁ without adversely impacting the position of the second stage 208 relative to the first stage 206. On the other hand, the gap distance G₁ can be increased using the support mover 228 in instances when the gap distance G₁ has become too small.

Further, the first, second and third positions illustrated in the Figures are merely representative of three positions of one of the first mover components 222 along a continuum of movement. In other words, there can be any number of positions between the second position and the third position for each of the first mover components 222.

FIG. 2F is a schematic that illustrates an embodiment of the sensing and control functions of the stage assembly 220 illustrated in FIGS. 2C-2E for positioning the second stage along the Z axis.

In one embodiment, the measurement system 19 (illustrated in FIG. 1) includes one or more sensors that can monitor the position of the second stage relative to the first stage and/or the position of second stage relative to another structure, such as the optical assembly 16 (illustrated in FIG. 1) or another suitable component of the precision assembly 10.

In FIG. 2F, a trajectory s248, or desired path for the focused optical system to follow is determined based on the desired path of the wafer or other object to which the focused optical system is to be applied. The trajectory s248 is next fed into the control system. The trajectory s248 is compared with a sensor signal vector S that is generated from the output of the measurement system s250 measuring the present position of the second stage 208 relative to the optical assembly or another structure within the precision assembly. A difference vector is determined by comparing the trajectory s248 to the sensor signal vector S. The difference vector is transformed to a CG (center of gravity) coordinate frame through inverse transformation s252. The control law s254 prescribes the corrective action for the signal. The control law may be in the form of a PID . (proportional integral derivative) controller, proportional gain controller or a lead- lag filter, or other commonly known law in the art of control, for example.

The corrected CG signal is transformed to a value of force to be generated by the electromagnetic actuators of the vertical mover subassemblies s256. The force to be generated s256 and the gap distance (measured by E/I core gap sensors illustrated by arrow s258) for each vertical mover are then used during El commutation s260 to determine the current to be directed to the vertical mover subassemblies. The gap distances are measured by E/I core gap sensors s258, which can include one or more encoders, for example. The current is then directed to the vertical mover subassemblies and the vertical mover subassemblies move the second stage s262. The movement of the second stage is measured s250 and the sensor vector signal S is fed back and compared to the trajectory s248 and the cycle is repeated.

Additionally, one or more EI core gap sensors s258 feed information regarding the gap distances to the support mover sensor for coordinate transformation s264. This transforms the gap distances to a value of force to be generated by the support mover for moving the support mover carriage, and thus the component support and the first mover component. The control law s266 prescribes the current to be directed to the support mover s268. The control law s266 may be in the form of a PID (proportional integral derivative) controller, proportional gain controller or a lead-lag filter, or other commonly known law in the art of control. The current is directed to the support mover s268, and the support mover is positioned s270. The position of one or more components of the support mover is monitored by the support mover sensor s272 and can be continually fed back prior to applying the control law s266.

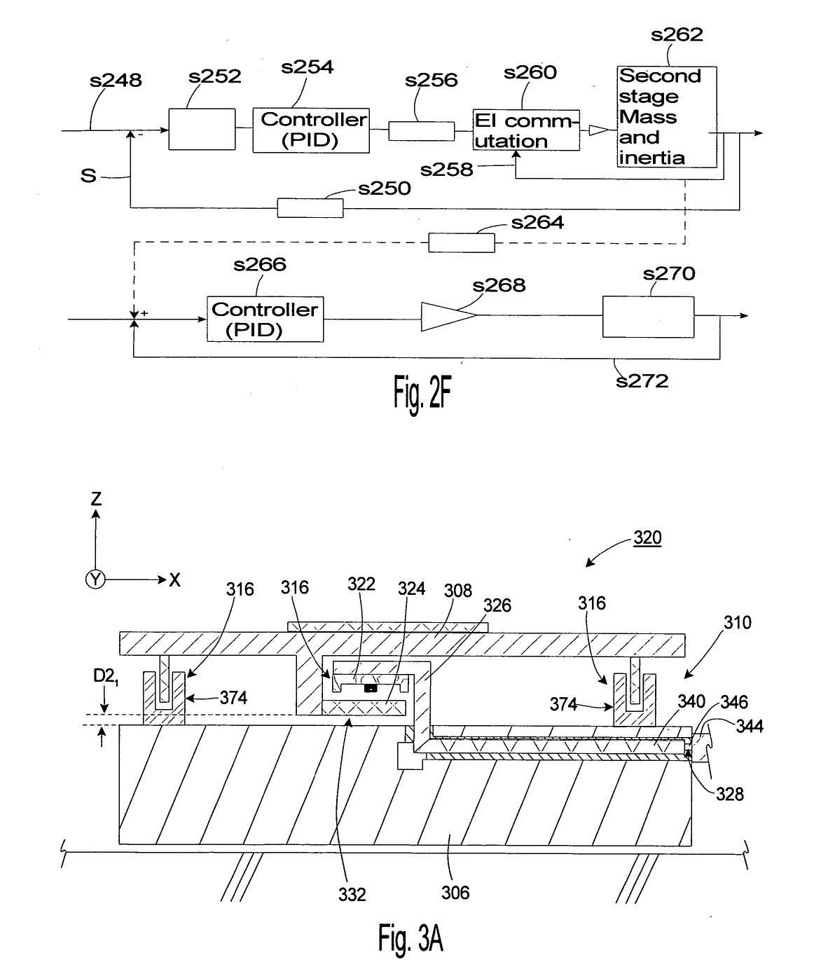

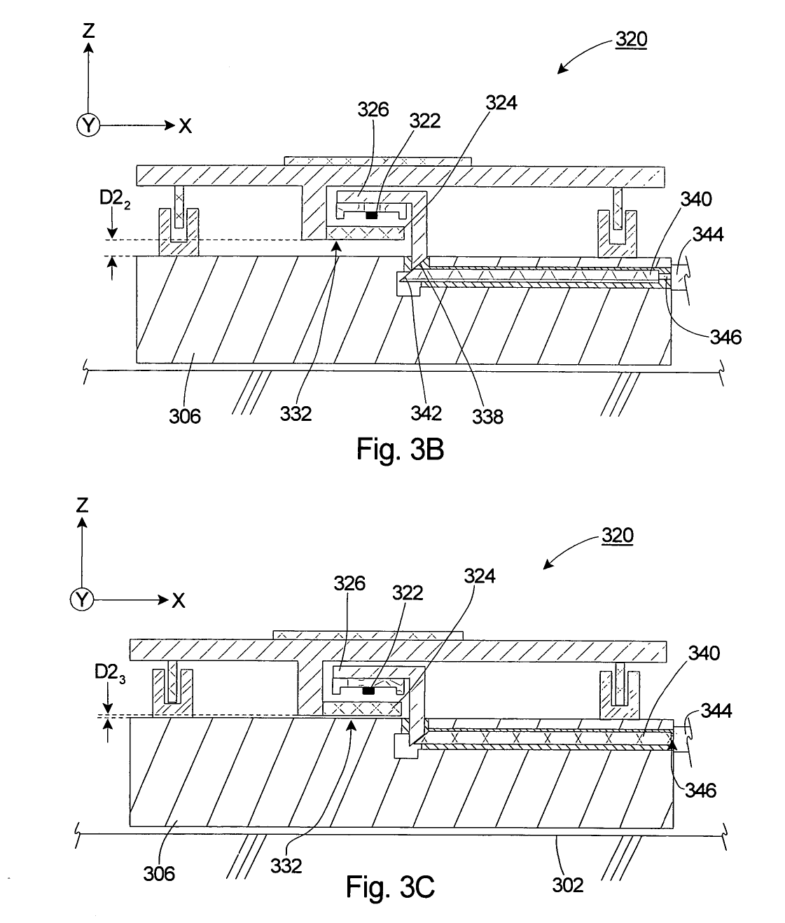

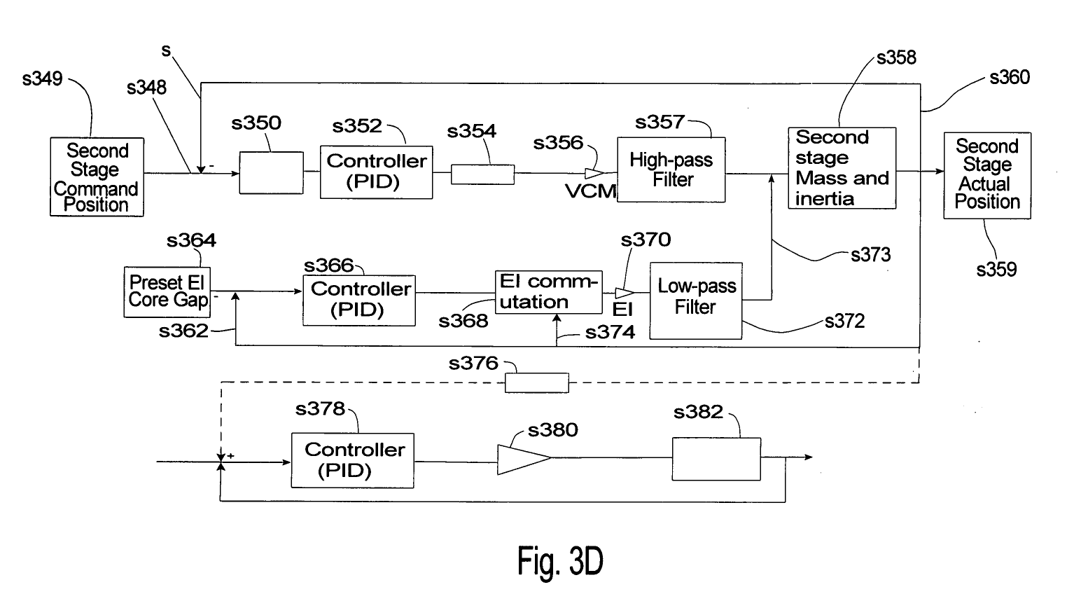

FIG. 3A is a cross-sectional view of another embodiment of a stage assembly 320 including a second stage mover assembly 310. In this embodiment, the second stage mover assembly 310 includes a plurality of vertical mover subassemblies 316 and one or more horizontal mover subassemblies (not shown for clarity). The vertical mover subassemblies 316 include a combination of one or more E/I core actuators 332 (only one E/I core actuator 332 is illustrated in FIG. 3A) and one or more voice coil motors 374 (two voice coil motors 374 are illustrated in FIG. 3A) for moving the second stage 308 substantially along the Z axis, about the X axis and/or about the Y axis. The number of E/I core actuators 332 and/or voice coil motors 374 can vary. Further, the positioning of each of the vertical mover subassemblies 316 can vary depending upon the number of vertical mover subassemblies 316 used, and the design requirements of the stage assembly 320. In alternate embodiments, vertical mover subassemblies 316 other than voice coil motors 374 can be used.

In the embodiment illustrated in FIG. 3A, the E/I core actuator(s) 332 can be used to preload the second stage 308. Stated another way, the E/I core actuator(s) 332 can counteract the force of gravity that acts on the second stage 308, and can maintain the second stage 308 at a given vertical distance above the first stage 306. With this design, the one or more voice coil motors 374 can more easily and accurately position the second stage 308 relative to the first stage 306 or another structure of the precision assembly 10. Moreover, because the second stage 308 has been preloaded by the E/I core actuator(s) 332, less force is required by the voice coil motors 374 to precisely adjust the position of the second stage 308.

Alternatively, the voice coil motors 374 can be used to preload the second stage 308, while the E/I core actuator(s) 374 can be utilized to precisely position the second stage 308 along the Z axis, about the X axis and/or about the Y axis.

In the embodiment illustrated in FIG. 3A, the E/I core actuators 332 each includes a first mover component 322 and a second mover component 324 that operate somewhat similarly to the mover components previously described herein. In addition, the second stage mover assembly,310 includes a component support 326 and a support mover 328 that cooperate to position the first mover component 322 in a somewhat similar manner as previously described herein. In other words, the component support 326 and the support mover 328 are used to raise and/or lower the first mover component 322 relative to the first stage 306 in a direction substantially parallel to the Z axis. In this embodiment, the support mover includes a support mover motor 344, a lead screw 346 and a support mover carriage 340. The attractive forces between the first mover component(s) 322 and the second mover component(s) 324 can position the second stage 306 and/or maintain the position of the second stage 308 relative to the first stage 306 substantially along the Z axis, and/or about the X and/or Y axes.

In the embodiment illustrated in FIG. 3A, the E/I core actuator 332 is shown in a first position. As used herein, the first position can be any position that still allows the first mover component 322 to be both raised and lowered from that position. Stated another way, the first position can be in a somewhat intermediate location of the total stroke of the first mover component 322 relative to the first stage 306 along the Z axis.

As a result of the positioning of the first mover component 322, in conjunction with the attractive force between the mover components 322, 324, the second mover component 324 is positioned a second mover component distance D2₁ from the first stage 306, which can vary depending upon the amount of the attractive force between the mover components 322, 324.

The second stage mover assembly 310 provided herein allows the mover components 322, 324 to remain relatively close together, without unduly limiting the stroke of the second stage 308 in a direction along the Z axis, or rotation about the X axis and/or about the Y axis. Thus, the attractive force between the mover components 322, 324 can continue to finely control the vertical positioning of the second stage 308 regardless of the distance between the second stage 308 and the first stage 306.

FIG. 3B is a cross-sectional view of the stage assembly 320 including the E/I core actuator 332 shown in a second position. In the second position, the support mover motor 344 has rotated the lead screw 346 so that the support mover carriage 340 has moved away from the support mover motor 344 in a direction that is substantially along the X-Y plane.

As used herein, the second position represents an upper end of the total vertical stroke of the first mover component 322. To reach the second position, the mover surface 342 movably contacts the support surface 338, causing an upward force on the component support 326 that raises the component support 326 and the first mover component 322 relative to the first stage 306.

As a result of the positioning of the first mover component 322, in conjunction with the attractive force between the mover components 322, 324, the second mover component 324 is positioned a second mover component distance D2₂ from the first stage 306, which can vary depending upon the amount of the attractive force between the mover components 322, 324. In the example provided herein, D2₂>D2₁.

FIG. 3C is a cross-sectional view of the stage assembly 320 including the E/I core actuator 332 shown in a third position. In the third position, the support mover motor 344 has rotated the lead screw 346 so that the support mover carriage 340 has moved toward the support mover motor 344 substantially along the X-Y plane.

As used herein, the third position represents a lower end of the total vertical stroke of the first mover component 322. To reach the third position, the mover surface 342 moves towards the support mover motor 344, allowing the force of gravity to move the component support 326 substantially downward toward the stage base 302 along the Z axis. This movement of the component support 326 lowers the first mover component 322 relative to the first stage 306 along the Z axis.

As a result of the positioning of the first mover component 322, in conjunction with the attractive force between the mover components 322, 324, the second mover component 324 is positioned a second mover component distance D2₃ from the first stage 306, which can vary depending upon the amount of the attractive force between the mover components 322, 324. In the example provided herein, D2₃<D2₁.

FIG. 3D is a schematic that illustrates an embodiment of the sensing and control functions of the stage assembly 320 illustrated in FIGS. 3A-3C. In one embodiment, the measurement system 19 (illustrated in FIG. 1) includes one or more sensors that can monitor the position of the second stage relative to the first stage and/or the position of second stage relative to another structure, such as the optical assembly or another suitable component of the precision assembly. In this embodiment, the actuators coordinate so that the potential for conflicting movements of the actuators is reduced.

In FIG. 3D, a trajectory s348, or desired path for the focused optical system to follow is determined based on a second stage command position s349, e.g. a desired path of the wafer or other object to which the focused optical system is to be applied. The trajectory s348 is next fed into the control system. The trajectory s348 is compared with a sensor signal vector S that is generated from the output of the measurement system measuring the present position of the second stage relative to the optical assembly or another structure within the precision assembly. A difference vector is determined by comparing the trajectory s348 to the sensor signal vector S. The difference vector is transformed to a CG (center of gravity) coordinate frame through an inverse transformation s350. The control law s352 prescribes the corrective action for the signal. The control law may be in the form of a PID (proportional integral derivative) controller, proportional gain controller or a lead-lag filter, or other commonly known law in the art of control, for example.

The corrective action as determined by the control law s352 is converted through coordinate transformation to the force required by the voice coil motors to vertically move the first stage as required s354. This transforms the CG signal to a current that is to be directed to the voice coil motors of the vertical mover subassemblies s356. The current is then subject to a high-pass filter s357 which can attenuate the low-frequency influence on the second stage. The current is then directed to the vertical mover subassemblies and the vertical mover subassemblies move the second stage s358 to a second stage actual position s359. The movement of the second stage is measured s360 and the sensor vector signal S is fed back and compared to the trajectory s348 and the cycle is repeated.

Further, the measurement system includes one or more El core gap sensors that measure the gap distances between the first mover components and corresponding second mover components s362. A signal from one or more of the E/I core gap sensors is compared with a preset EI core gap s364 as prescribed by the control system, and a control law is applied s366. Application of the control law s366 determines the corrective action to be applied to the signal. The control law may be in the form of a PID (proportional integral derivative) controller, proportional gain controller or a lead-lag filter, or other commonly known law in the art of control, for example.

During EI commutation s368, the required force to be applied by one or more of the E/I core actuators to properly position the second stage, or to properly preload the second stage relative to the force of gravity is determined. In one embodiment, the E/I core actuators can be responsible for the low-frequency spectrum of the force acting on the second stage. The control system then determines the amount of current necessary to achieve the required force s370. The current can also be subject to a low-pass filter s372. By adding a low-pass filter s372 to the force output, the effect of the high-frequency force of the E/I core actuators on the second stage can be greatly attenuated. The current is then directed to the E/I core actuators to move the second stage relative to the first stage s373. The measured gap distances s362 are then fed back and compared to the preset El core gap s364. Further, the measured gap distances s362 are fed back s374 for determining the force required to position the second stage.

Additionally, the measured gap distances s362 are transformed by coordinate transformation to a signal indicating the distance that the component support is required to move to properly position the first mover component relative to the second mover component s376. The control law s378 then determines a corrective action to be applied to the signal. The control law s378 may be in the form of a PID (proportional integral derivative) controller, proportional gain controller or a lead-lag filter, or other commonly known law in the art of control, for example.

Following application of the control law s378, the control system determines a force to be generated by the support mover for moving the support mover carriage, and thus the component support and the first mover component, and the appropriate amount of current is determined s380. The current is applied to move the support mover, and thus the component support and the first mover component. The position of one or more components of the support mover is monitored by the support mover sensor s382 and the position can be fed back and compared with the signal indicating the distance that the component support is required to move to properly position the first mover component relative to the second mover component s376.

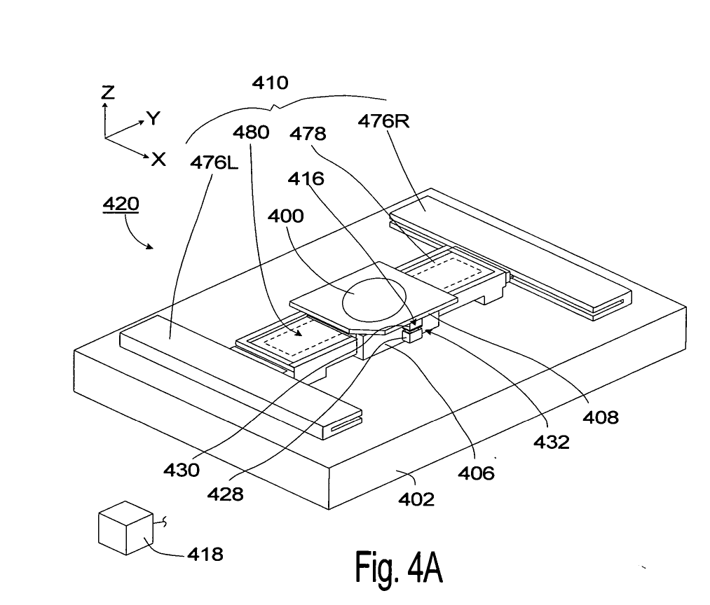

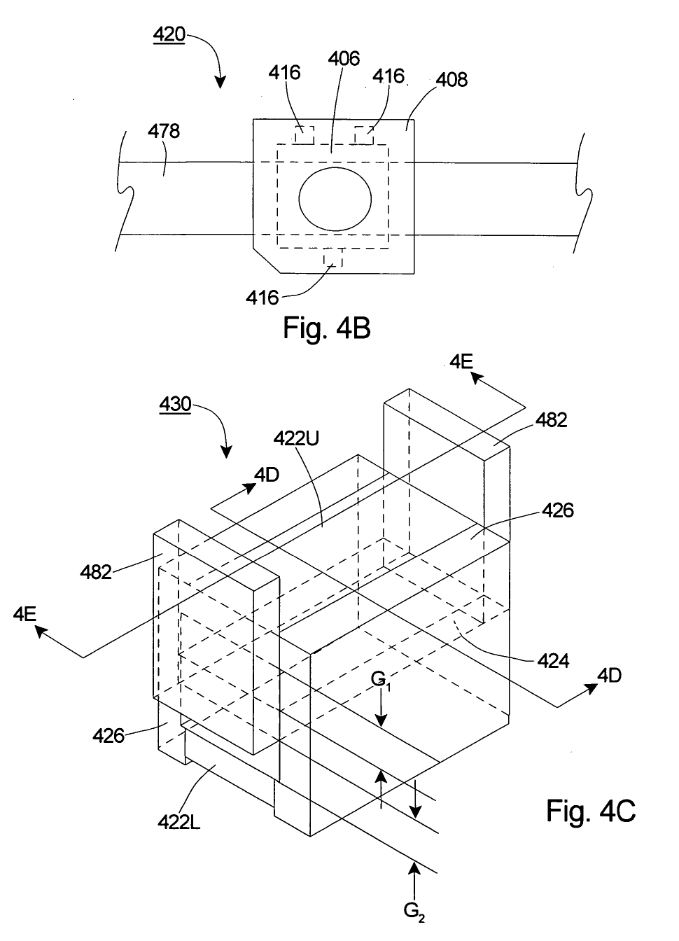

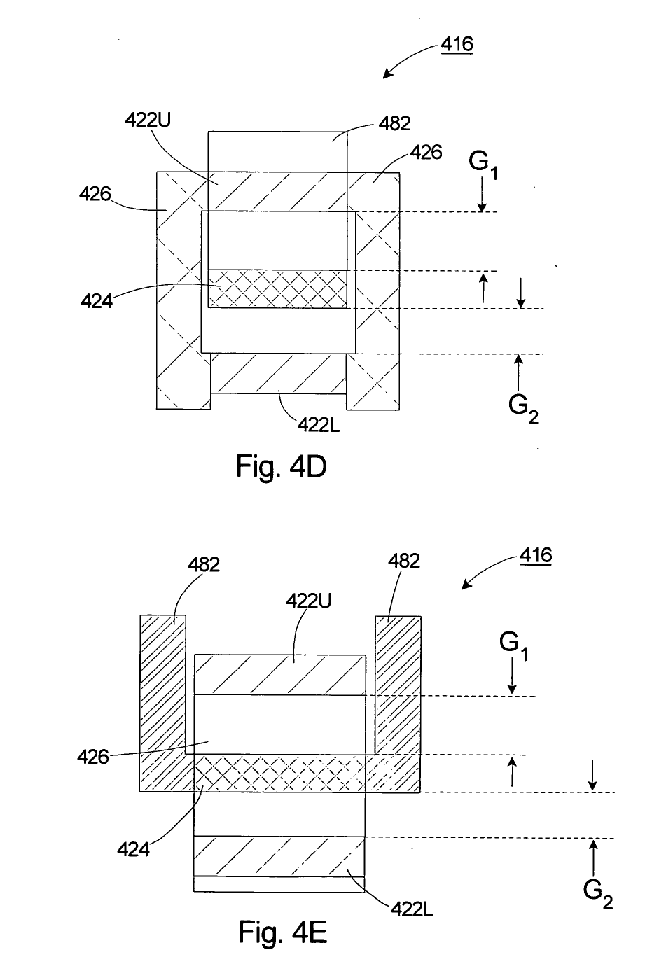

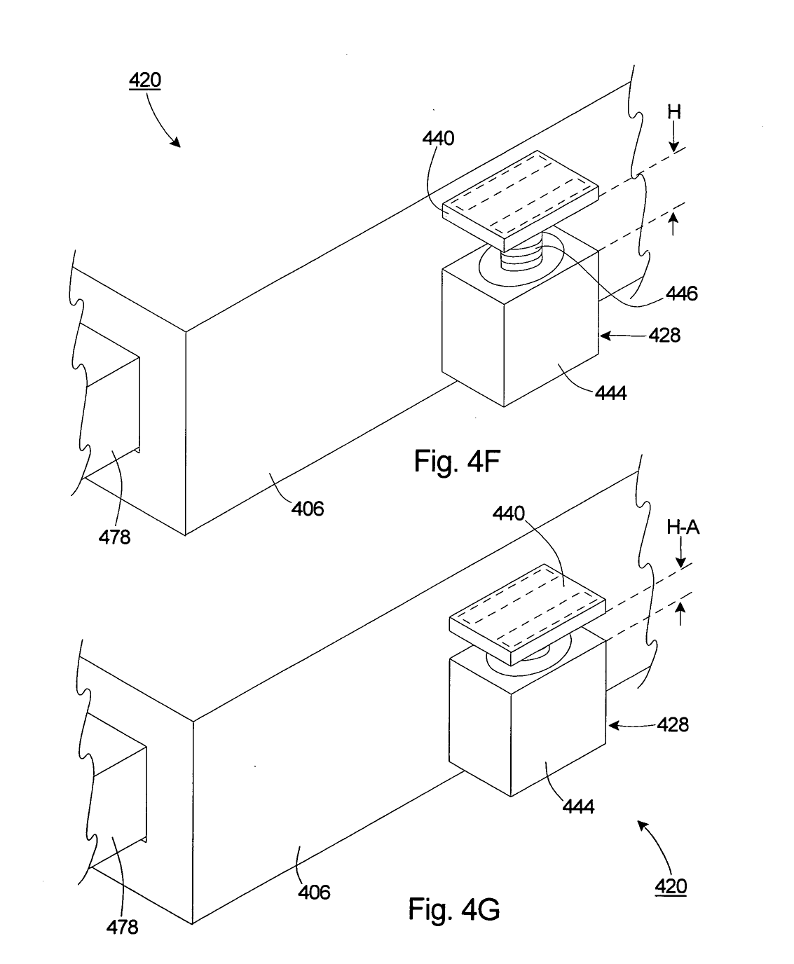

FIG. 4A is a perspective view of another embodiment of a stage assembly 420 that is used to position a device 400. In this embodiment, the stage assembly 420 includes a stage base 402, a stage mover assembly 410, a first stage 406, and a second stage 408. The design of the components of the stage assembly 420 can be varied. For example, in FIG. 4A, the stage assembly 420 includes two stages 406, 408. Alternatively, however, the stage assembly 420 could be designed to include greater or fewer than two stages.

The stage mover assembly 410 controls and moves the first stage 406 and/or the second stage 408 relative to the stage base 402. For example, the stage mover assembly 410 can move the second stage 408 with three degrees of freedom, less than three degrees of freedom, or six degrees of freedom relative to the stage base 402. The stage mover assembly 410 includes one or more electromagnetic movers 432 (one electromagnetic mover 432 is illustrated in FIG. 4A for clarity). The stage mover assembly 410 can also include one or more additional movers (not shown), such as rotary motors, voice coil motors, linear motors utilizing a Lorentz force to generate drive force, planar motors, or some other force movers, although such additional movers are not required.

In FIG. 4A, the stage mover assembly 410 includes a left X stage mover 476L, a right X stage mover 476R, a guide bar 478, a Y stage mover 480 and a control system 418 that directs current to the stage movers 476L, 476R, 480. The X stage movers 476L, 476R move the guide bar 478, the first stage 406 and the second stage 408 with a relatively large displacement along the X axis and with a limited range of motion about the Z axis, and the Y stage mover moves the first stage 406 and the second stage 408 with a relatively large displacement along the Y axis relative to the guide bar 478.

The design of each stage mover 476L, 476R, 480 can be varied to suit the movement requirements of the stage assembly 420. For example, each of the stage movers 476L, 476R, 480 can include one or more rotary motors, voice coil motors, linear motors utilizing a Lorentz force to generate drive force, electromagnetic movers, or some other force movers. In the embodiment illustrated in FIG. 4A, each of the stage movers, 476L, 476R, 480 is a linear motor.

The guide bar 478 guides the movement of the first stage 406 along the Y axis. In FIG. 4A, the guide bar 478 is somewhat rectangular and beam shaped. A bearing (not shown) maintains the guide bar 478 spaced apart along the Z axis relative to the stage base 402 and allows for motion of the guide bar 478 along the X axis and about the Z axis relative to the stage base 402. The bearing can be a vacuum preload type fluid bearing that maintains the guide bar 478 spaced apart from the stage base 402 in a non-contact manner. Alternatively, for example, a magnetic type bearing or a ball bearing type assembly could be utilized that allows for motion of the guide bar 478 relative to the stage base 402.

In FIG. 4A, the first stage 406 moves with the guide bar 478 along the X axis and about the Z axis and the first stage 406 moves along the Y axis relative to the guide bar 478. In this embodiment, the first stage 406 is generally rectangular shaped and includes a rectangular shaped opening for receiving the guide bar 478. A bearing (not shown) maintains the first stage 406 spaced apart along the Z axis relative to the stage base 402 and allows for motion of the first stage 406 along the X axis, along the Y axis and about the Z axis relative to the stage base 402. The bearing can be a vacuum preload type fluid bearing that maintains the first stage 406 spaced apart from the stage base 402 in a non-contact manner. Alternatively, for example, a magnetic type bearing or a ball bearing type assembly could be utilized that allows for motion of the first stage 406 relative to the stage base 402.

Further, the first stage 406 is maintained apart from the guide bar 478 with opposed bearings (not shown) that allow for motion of the first stage 406 along the Y axis relative to the guide bar 478, while inhibiting motion of the first stage 406 relative to the guide bar 478 along the X axis and about the Z axis. Each bearing can be a fluid bearing that maintains the first stage 406 spaced apart from the guide bar 478 in a non-contact manner. Alternatively, for example, a magnetic type bearing or a ball bearing type assembly could be utilized that allows for motion of the first stage 406 relative to the guide bar 478.

In the embodiment illustrated in the FIG. 4A, the second stage 408 is generally rectangular plate shaped and includes a clamp (not shown) that retains the device 400. Further, the stage mover assembly 410 can include a plurality of vertical mover subassemblies 416 (only one vertical mover subassembly 416 is illustrated in FIG. 4A) that move and adjust the position of the second stage 408 relative to the first stage 406 substantially along the Z axis, and/or about the X and/or Y axes. The stage mover assembly 410 can also include one or more horizontal mover subassemblies (not shown) that can adjust the position of the second stage 408 along the X axis, along the Y axis and/or about the Z axis. The control system 418 directs current to the vertical mover subassemblies 416 and the horizontal mover subassemblies to accurately position the device 400. For example, the stage mover assembly 410 can adjust the position of the second stage 408 relative to the first stage 406 with six degrees of freedom. Alternatively, for example, the stage mover assembly 410 can move the second stage 408 relative to the first stage 406 with three or fewer degrees of freedom.

In the embodiment illustrated in FIG. 4A, each vertical mover subassembly 416 includes an E/I core actuator pair 430 and a support mover 428. In one embodiment, the one or more E/I core actuator pairs 430 can position the second stage 408 with at least three degrees of freedom, i.e. along the Z axis, about the X axis and about the Y axis, as an example. In alternative embodiments, the E/I core actuator pairs 430 can position the second stage 408 with greater or fewer than three degrees of freedom. The design of the E/I core actuator pairs 430 and the support mover 428 can vary depending upon the design requirements of the stage assembly 420 and the precision assembly 10.

FIG. 4B illustrates a top view of one embodiment of a portion of the stage assembly 420 including the guide bar 478, the first stage 406 (shown in phantom), the second stage 408, and the vertical mover subassemblies 416 (shown in phantom). In this embodiment, three vertical mover subassemblies 416 are positioned substantially around the perimeter of the first stage 406. However, in alternative embodiments, greater or fewer than three vertical mover subassemblies 416 can be utilized. Further, the positioning of the vertical mover subassemblies 416 can vary depending upon the design requirements of the stage assembly 420.

FIG. 4C is a perspective view of an embodiment of one of the E/I core actuator pairs 430 illustrated in FIG. 4A. In this embodiment, the E/I core actuator pair 430 includes an upper first mover component 422U and a lower first mover component 422L, each of which is an “E”core; and a second mover component 424 (also referred to herein as an “I”core). In the embodiment illustrated in FIG. 4C, the functioning of the E/I core actuator pairs 430 is substantially similar to that previously described above for other E/I core actuator pairs.

Further, in this embodiment, one or more of the first mover components 422U, 422L can be secured to and supported by one or more component supports 426. The second mover component 424 can be secured to one or more second stage supports 482. The second stage supports 482 are coupled to and support the second stage 408 (illustrated in FIG. 4A) so that movement of the second mover component 424 vertically between the first mover components 422U, 422L causes the second stage supports 482 to raise and/or lower the second stage 408 in a direction that is substantially parallel to the Z axis, and/or about the X axis and/or about the Y axis.

In addition, the support mover 428 can position the component supports 426 by moving the component supports 426 vertically relative to the first stage (illustrated in FIG. 4A). With this design, the first mover components 422U, 422L can be moved vertically in order to maintain relatively consistent gap distances G₁, G₂ between the first mover components 422U, 422L and the second mover component 424, as illustrated in FIG. 4C. Stated another way, the support mover 428 can be used in conjunction with the control system 418 (illustrated in FIG. 4A) so that G₁≈G₂.

FIG. 4D is a cross-sectional view taken on line 4D-4D in FIG. 4C. FIG. 4D illustrates the structure of a portion of the vertical mover subassembly 416, including the upper first mover component 422U, the lower first mover component 422L, the second mover component 424, the component supports 426 and the second stage supports 482 (only one second stage support is illustrated in FIG. 4D). As illustrated in FIG. 4D, the second mover component 424 is positioned a first gap distance G₁ away from the upper first mover component 422U. The second mover component 424 is also positioned a second gap distance G₂ from the lower first mover component 422L. The gap distances G₁, G₂ can be varied depending upon the level of current that is directed to the first mover components 422U, 422L, as previously described herein. However, as provided below, the present invention can decrease the likelihood of collision between the second mover component 424 and either of the first mover components 422U, 422L. Moreover, the second mover component 424 can be maintained in a position such that G₁ is approximately equal to G₂, which can increase the potential vertical stroke of the second mover component 424, and thus the second stage 408 (illustrated in FIG. 4A), in either or both directions substantially along the Z axis.

FIG. 4E is cross-sectional view taken on line 4E-4E in FIG. 4C. FIG. 4E assists in illustrating the structure of a portion of the vertical mover subassembly 416, including the upper first mover component 422U, the lower first mover component 422L, the second mover component 424, the component supports 426 (only one component support is illustrated in FIG. 4E) and the second stage supports 482.

FIG. 4F is a perspective view of a portion of the stage assembly 420 illustrated in FIG. 4A, including a portion of the guide bar 478, a portion of the first stage 406, and one support mover 428 shown in a first position. The E/I core actuator pair 430, the component supports 426 and the second stage supports 482 have been omitted for clarity. The support mover 428 positions the component supports 426, and thus the E/I core actuator pair 430, relative to the first stage 406. Stated another way, the component supports 426 and the support movers 428 cooperate to raise and/or lower one or more of the first mover components 422U, 422L, (illustrated in FIG. 4C) e.g. movement substantially parallel to the Z axis. The design of the support mover 428 can vary. Any suitable actuator can be used for the support mover 428. In the embodiment illustrated in FIG. 4F, each support mover 428 can include a support mover motor 444, a lead screw 446 and a support mover carriage 440.

The control system 418 (illustrated in FIG. 4A) directs current to the support mover motor 444, which can then rotate the lead screw 446, thereby raising and/or lowering the support mover carriage 440 substantially along the Z axis. In the embodiment illustrated in FIG. 4F, the support mover carriage 440 is shown in a theoretically completely raised position. FIG. 4F illustrates a height difference H between the support mover carriage 440 and the support mover motor 444. The actual height difference H can be varied depending upon the requirements of the stage assembly 420 and the precision assembly 10.

Movement of the support mover carriage 440 substantially along the Z axis results in movement of the component supports 426 and the first mover components 422U, 422L also substantially along the Z axis. Because movement of the second mover component 424 (illustrated in FIG. 4C) is at least partly dependent upon the positioning of the first mover components 422U, 422L, the second mover component 424 can somewhat similarly move substantially along the Z axis. Movement of one or more of the second mover components 424 causes movement of the second stage 408 (illustrated in FIG. 4A) substantially along the Z axis, and/or about the X and/or Y axes.

FIG. 4G is a perspective view of a portion of the stage assembly 420 illustrated in FIG. 4A, including a portion of the guide bar 478, a portion of the first stage 406, and one support mover 428 shown in a second position. In the second position, the support mover carriage 440 has been lowered by the support mover motor 444 to a theoretically completely lowered position. FIG. 4G illustrates a height difference H−A, between the support mover carriage 440 and the support mover motor 444. In this example, A is equal to the total stroke of the support mover 428, e.g. the total distance that the support mover carriage 440 can be moved substantially along the Z axis. The total stroke A of the support mover 428 can vary. For example, the total stroke A can be up to 5 millimeters or more.

By utilizing the support mover 428 to raise and lower the E/I core actuator pair 430 (illustrated in FIG. 4C), a greater total stroke of the second stage 408 (illustrated in FIG. 4A) along the Z axis, about the X axis and/or about the Y axis is achieved, without the necessity of directing more current to the E/I core actuator pair 430. As a result, the heat generated by the E/I core actuator pair 430 is decreased, and less power is consumed. Additionally, the incidence of collision between one or more of the mover components 422U, 422L, 424 (illustrated in FIG. 4C) is decreased.

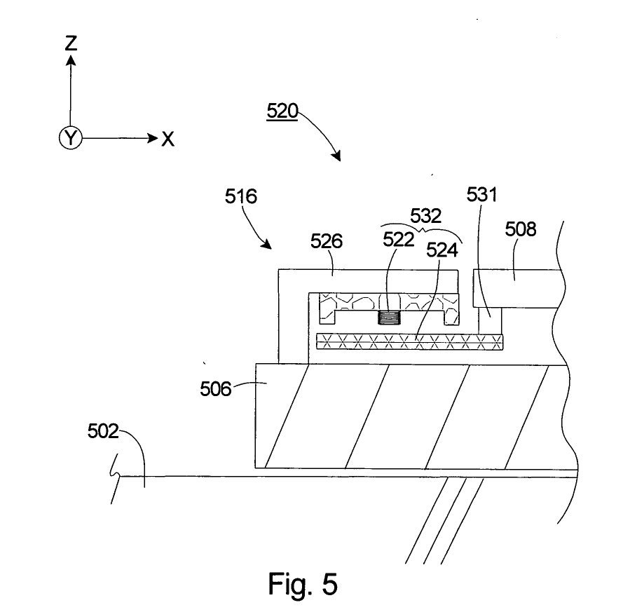

FIG. 5 is a cross-sectional view of a portion of an alternative embodiment of the stage assembly 520. In this embodiment, the vertical mover subassembly 516 includes a first mover 531 and a second mover 532. The first mover 531 moves and positions the second stage 508 relative to the first stage 506 substantially along the Z axis. For example, the first mover 531 can include one or more rotary motors, voice coil motors, linear motors utilizing a Lorentz force to generate drive force, electromagnetic actuators, planar motors, or some other force actuators. Additionally, by using a plurality of vertical mover subassemblies 516, each including at least one first mover 531, the second stage 508 can also be positioned about the X axis and/or about the Y axis.

In this embodiment, the second mover 532 includes an E/I core actuator having a first mover component 522 and a second mover component 524. The first mover component 522 is secured to and supported by a component support 526, which can be fixedly secured to the first stage 506. The second mover component 524 is secured to the first mover 531. With this design, one of the movers 531, 532 can be utilized as a coarse mover that can move the second stage 508 along the Z axis, about the X axis and/or about the Y axis a relatively large distance, and the remaining mover can be used as a fine mover for fine-tuning the position of the second stage 508 along the Z axis, about the. X axis and/or about the Y axis.

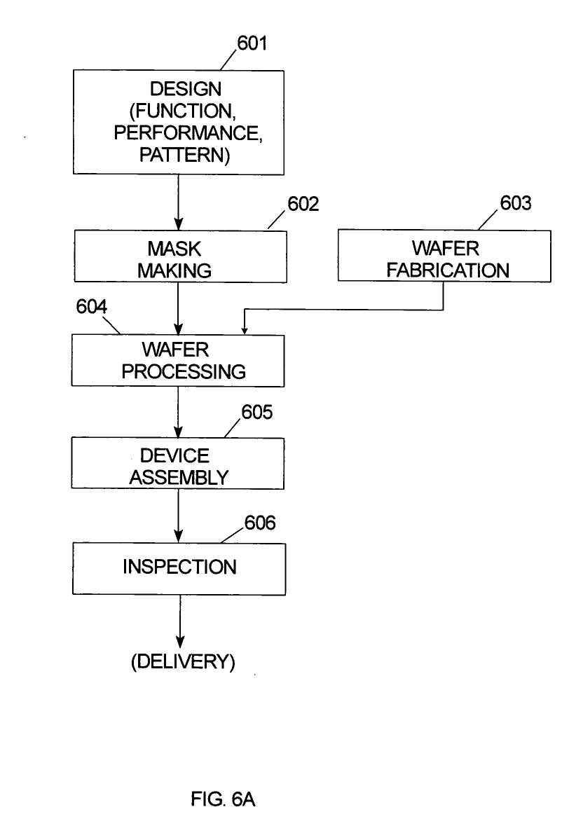

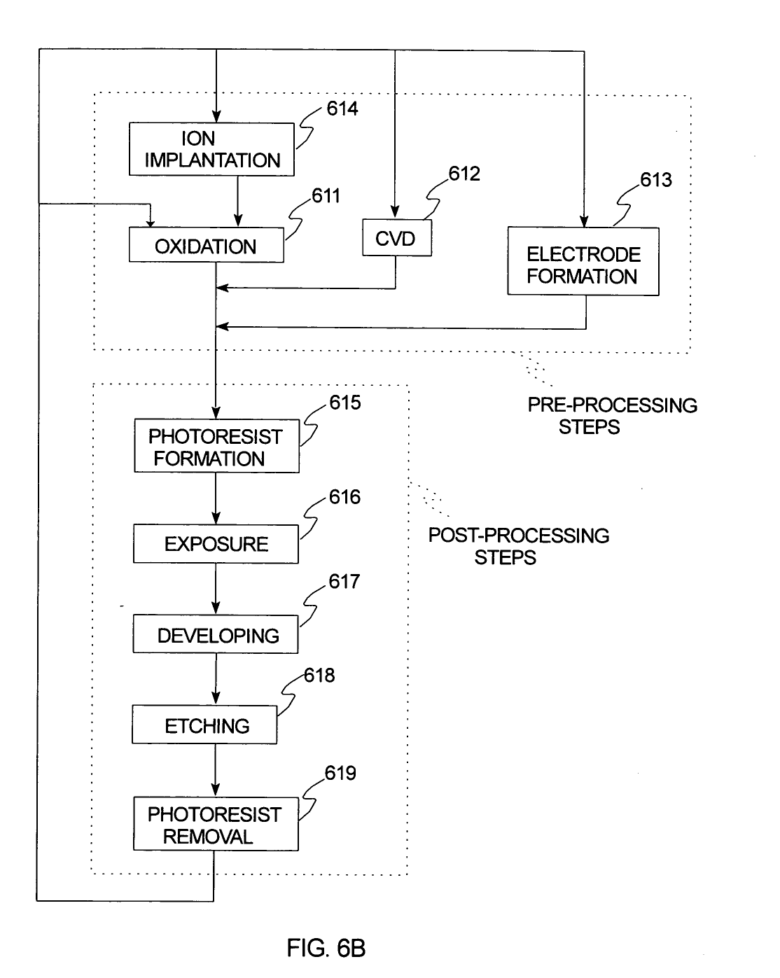

Semiconductor devices can be fabricated using the above described systems, by the process shown generally in FIG. 6A. In step 601 the device's function and performance characteristics are designed. Next, in step 602, a mask (reticle) having a pattern is designed according to the previous designing step, and in a parallel step 603 a wafer is made from a silicon material. The mask pattern designed in step 602 is exposed onto the wafer from step 603 in step 604 by a photolithography system described hereinabove in accordance with the present invention. In step 605 the semiconductor device is assembled (including the dicing process, bonding process and packaging process), finally, the device is then inspected in step 606.

FIG. 6B illustrates a detailed flowchart example of the above-mentioned step 604 in the case of fabricating semiconductor devices. In FIG. 6B, in step 611 (oxidation step), the wafer surface is oxidized. In step 612 (CVD step), an insulation film is formed on the wafer surface. In step 613 (electrode formation step), electrodes are formed on the wafer by vapor deposition. In step 614 (ion implantation step), ions are implanted in the wafer. The above mentioned steps 611-614 form the preprocessing steps for wafers during wafer processing, and selection is made at each step according to processing requirements.

At each stage of wafer processing, when the above-mentioned preprocessing steps have been completed, the following post-processing steps are implemented. During post-processing, first, in step 615 (photoresist formation step), photoresist is applied to a wafer. Next, in step 616 (exposure step), the above-mentioned exposure device is used to transfer the circuit pattern of a mask (reticle) to a wafer. Then in step 617 (developing step), the exposed wafer is developed, and in step 618 (etching step), parts other than residual photoresist (exposed material surface) are removed by etching. In step 619 (photoresist removal step), unnecessary photoresist remaining after etching is removed. Multiple circuit patterns are formed by repetition of these preprocessing and post- processing steps.

While the particular stage assembly 220 and precision assembly 10 as shown and disclosed herein is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A stage assembly for positioning a device, the stage assembly comprising:
a first stage;
a second stage that supports the device, the second stage being supported by the first stage; and
a mover assembly that moves the second stage relative to the first stage, the mover assembly including a support mover and a first mover component that is coupled to the support mover, the support mover moving the first mover component to change a distance between the first mover component and one of the stages.

2. The stage assembly of claim 1 wherein the mover assembly moves the second stage in a direction that is substantially toward and away from the first stage.

3. The stage assembly of claim 1 wherein the first mover component is a part of an attraction-only type actuator that moves the second stage with one degree of freedom in a direction that is substantially toward and away from the first stage.

4. The stage assembly of claim 3 wherein the mover assembly includes a plurality of attraction-only type actuators that move the second stage with three degrees of freedom relative to the first stage.

5. The stage assembly of claim 3 wherein the mover assembly includes a voice coil motor that moves the second stage to change a distance between the first stage and the second stage.

6. The stage assembly of claim 5 wherein the mover assembly moves the second stage with three degrees of freedom relative to the first stage.

7. The stage assembly of claim 1 wherein the first mover component includes an E core that is coupled to the support mover.

8. The stage assembly of claim 7 wherein the mover assembly includes a second mover component that interacts with the first mover component to move the second stage, the second mover component being secured to the second stage.

9. The stage assembly of claim 8 wherein the second mover component includes an I core that moves substantially toward and away from the first stage.

10. The stage assembly of claim 1 wherein the support mover includes an angled mover surface and the mover assembly includes a component support having an angled support surface, the mover surface moving against the support surface to move a portion of the component support in a direction that is substantially away from the first stage.

11. The stage assembly of claim 10 wherein the first stage has a upper surface, and wherein at least one of the mover surface and the support surface has an angle with an absolute value that is approximately greater than 10 degrees and less than 80 degrees relative to the upper surface.

12. The stage assembly of claim 10 wherein the first stage has a upper surface, and wherein the mover surface and the support surface are angled relative to the upper surface, and wherein the sum of the angle of the mover surface and the angle of the support surface is greater than approximately 60 degrees and less than approximately 120 degrees.

13. The stage assembly of claim 10 wherein the first stage has a upper surface, and wherein the mover surface and the support surface are angled relative to the upper surface, and wherein the sum of the angle of the mover surface and the angle of the support surface is approximately 90 degrees.

14. The stage assembly of claim 1 further comprising a stage base that supports the first stage, wherein the first stage moves with three degrees of freedom relative to the stage base.

15. The stage assembly of claim 1 wherein the support mover includes a mover motor and a support mover carriage, the mover motor causing the support mover carriage to move in a first direction that moves the first mover component in a second direction that is different than the first direction.

16. The stage assembly of claim 1 further comprising a control system that directs current to the first mover component to control movement of the second stage in a direction that is substantially toward and away from the first stage.

17. The stage assembly of claim 16 further comprising a sensor, wherein the mover assembly includes a second mover component that cooperates with the first mover component to move the second stage relative to the first stage, the sensor monitoring a gap distance between the first mover component and the second mover component.

18. The stage assembly of claim 17 wherein the control system receives information from the sensor including the gap distance to control movement of the support mover.

19. The stage assembly of claim 16 further comprising a first sensor that monitors movement of the support mover relative to the component support.

20. The stage assembly of claim 19 wherein the mover assembly includes a component support that supports the first mover component, and wherein the control system receives information from the first sensor including movement of the support mover relative to the component support to control the amount of current that is directed to the first mover component.

21. The stage assembly of claim 20 further comprising a second sensor, and wherein the mover assembly includes a second mover component that cooperates with the first mover component to move the second stage relative to the first stage, the second sensor monitoring a gap distance between the first mover component and the second mover component.

22. The stage assembly of claim 21 wherein the control system receives information from the second sensor including the gap distance to control movement of the support mover.

23. A precision assembly including an illumination source and the stage assembly of claim 1 positioned near the illumination source.

24. A device manufactured with the precision assembly of claim 23.

25. A wafer on which an image has been formed by the precision assembly of claim 23.

26. A stage assembly for positioning a device, the stage assembly comprising:
a stage base having a guide surface;
a first stage that is supported by the stage base, the first stage moving relative to the guide surface;
a second stage that supports the device;
a first mover subassembly including a first mover and a second mover that are arranged in series, the movers cooperating to move the second stage relative to the first stage.

27. The stage assembly of claim 26 wherein one of the movers includes an attraction-only type actuator.

28. The stage assembly of claim 27 wherein the movers cooperate to move the second stage with one degree of freedom along an axis that is substantially perpendicular to the guide surface.

29. The stage assembly of claim 26 wherein the movers cooperate to move the second stage with three degrees of freedom relative to the first stage.

30. The stage assembly of claim 26 further comprising a second mover subassembly that cooperates with the first mover subassembly to move the second stage with three degrees of freedom relative to the first stage.

31. The stage assembly of claim 26 further comprising a voice coil motor that moves the second stage to change a distance between the first stage and the second stage.

32. The stage assembly of claim 31 wherein the voice coil motor moves the second stage with three degrees of freedom relative to the first stage.

33. The stage assembly of claim 26 wherein the first mover directly moves a portion of the second mover.

34. The stage assembly of claim 26 wherein the first mover is secured to the first stage and the second mover is secured to the second stage.

35. The stage assembly of claim 26 wherein the second mover moves the second stage relative to the first mover.

36. The stage assembly of claim 26 wherein the first mover includes (i) a first mover component having an angled mover surface, and (ii) a second mover component having an angled support surface, and wherein the mover surface moves against the support surface to move a portion of the second mover component in a direction that is substantially away from the first stage.

37. The stage assembly of claim 26 wherein the first stage moves with three degrees of freedom relative to the guide surface.

38. The stage assembly of claim 26 wherein a portion of the first mover is secured to a portion of the second mover.

39. The stage assembly of claim 26 wherein the first mover moves a portion of the second mover along an axis that is substantially perpendicular to the guide surface.

40. The stage assembly of claim 39 wherein the second mover moves the second stage along an axis that is substantially perpendicular to the guide surface.

41. The stage assembly of claim 26 further comprising a control system that directs current to the first mover subassembly to control movement of the second stage along an axis that is substantially perpendicular to the guide surface.

42. The stage assembly of claim 26 further comprising a first sensor, wherein the first mover includes an attraction-only type actuator having a first mover component and a second mover component, the sensor monitoring a gap distance between the first mover component and the second mover component.

43. The stage assembly of claim 42 wherein the control system receives information from the sensor including the gap distance to control movement of the second mover.

44. The stage assembly of claim 42 further comprising a second sensor, wherein the second mover includes a first mover component and a second mover component, and wherein the control system receives information from the second sensor including movement of the first mover component of the second mover relative to the second mover component of the second mover to control the amount of current that is directed to one of the movers.

45. A precision assembly including an illumination source and the stage assembly of claim 26 positioned near the illumination source.

46. A device manufactured with the precision assembly of claim 45.

47. A wafer on which an image has been formed by the precision assembly of claim 45.

48. A stage assembly for positioning a device, the stage assembly comprising:
a stage base having a guide surface;
a device table that is supported by the stage base, the device table supporting the device; and
a first mover subassembly including a first mover and a second mover that are positioned in series, the movers cooperating to move the device table along an axis that is substantially perpendicular to the guide surface.

49. The stage assembly of claim 48 wherein one of the movers includes an attraction-only type actuator.

50. The stage assembly of claim 48 wherein the movers cooperate to move the device table with three degrees of freedom relative to the guide surface.

51. The stage assembly of claim 48 further comprising a second mover subassembly that cooperates with the first mover subassembly to move the device table with three degrees of freedom relative to the guide surface.

52. The stage assembly of claim 48 further comprising a voice coil motor that moves the device table to change a distance between the guide surface and the device table.

53. The stage assembly of claim 52 wherein the voice coil motor moves the device table with three degrees of freedom relative to the guide surface.

54. The stage assembly of claim 48 wherein the first mover directly moves a portion of the second mover.

55. The stage assembly of claim 48 wherein the second mover moves the device table relative to the first mover.

56. The stage assembly of claim 48 wherein the first mover includes (i) a first mover component having an angled mover surface, and (ii) a second mover component having an angled support surface, and wherein the mover surface moves against the support surface to move a portion of the second mover component along an axis that is substantially perpendicular to the guide surface.

57. The stage assembly of claim 48 wherein a portion of the first mover is secured to a portion of the second mover.

58. The stage assembly of claim 48 wherein the first mover moves a portion of the second mover along an axis that is substantially perpendicular to the guide surface.

59. The stage assembly of claim 58 wherein the second mover moves the device table along an axis that is substantially perpendicular to the guide surface.

60. The stage assembly of claim 48 further comprising a control system that directs current to the first mover subassembly to control movement of the device table along an axis that is substantially perpendicular to the guide surface.

61. The stage assembly of claim 48 further comprising a first sensor, wherein the first mover includes an attraction-only type actuator having a first mover component and a second mover component, the sensor monitoring a gap distance between the first mover component and the second mover component.

62. The stage assembly of claim 61 wherein the control system receives information from the sensor including the gap distance to control movement of the second mover.

63. The stage assembly of claim 61 further comprising a second sensor, wherein the second mover includes a first mover component and a second mover component, and wherein the control system receives information from the second sensor including movement of the first mover component of the second mover relative to the second mover component of the second mover to control the amount of current that is directed to one of the movers.

64. A precision assembly including an illumination source and the stage assembly of claim 48 positioned near the illumination source.

65. A device manufactured with the precision assembly of claim 64.

66. A wafer on which an image has been formed by the precision assembly of claim 64.

67. A method for positioning a device, the method comprising the steps of:
supporting a first stage with a stage base having a guide surface;
moving the first stage relative to the guide surface;
supporting the device with a second stage; and
moving the second stage relative to the first stage with a first mover and a second mover that are arranged in series.

68. The method of claim 67 wherein the step of moving the second stage includes using the first mover to move a portion of the second mover.

69. The method of claim 67 wherein the step of moving the second stage includes moving the second stage along an axis that is substantially perpendicular to the guide surface.

70. The method of claim 67 wherein the step of moving the second stage includes using an attraction-only type actuator.

71. The method of claim 67 wherein the step of moving the second stage includes using the movers to move the second stage with three degrees of freedom relative to the first stage.

72. The method of claim 67 further comprising the step of moving the second stage relative to the first stage with a voice coil motor along an axis that is substantially perpendicular to the guide surface.

73. The method of claim 67 wherein the step of moving the second stage includes securing the first mover to the first stage and securing the second mover to the second stage.

74. The method of claim 67 wherein the step of moving the second stage includes using the second mover to move the second stage relative to the first mover.

75. The method of claim 67 wherein the step of moving the first stage includes moving the first stage with three degrees of freedom relative to the guide surface.

76. The method of claim 67 wherein the step of moving the second stage includes securing a portion of the first mover to a portion of the second mover.

77. The method of claim 67 wherein the step of moving the second stage includes using the first mover to move a portion of the second mover along an axis that is substantially perpendicular to the guide surface.

78. The method of claim 77 wherein the step of moving the second stage includes using the second mover to move the second stage along an axis that is substantially perpendicular to the guide surface.

79. The method of claim 67 wherein the step of moving the second stage includes directing current to the first mover to control movement of the second stage along an axis that is substantially perpendicular to the guide surface.

80. The method of claim 67 wherein the step of moving the second stage includes monitoring a gap distance between a first mover component of the first mover and a second mover component of the first mover with a first sensor, and controlling movement of the second mover based at least partly on the gap distance.

81. The method of claim 80 wherein the step of moving the second stage includes monitoring movement of a first mover component of the second mover relative to a second mover component of the second mover with a second sensor, and directing current to one of the movers based at least partly on the movement monitored by the second sensor.

82. A method for making an exposure apparatus for transferring an image onto the device, the method comprising the steps of:
providing an illumination system that directs an illumination beam at the reticle; and
positioning the device utilizing the method of claim 67.

83. A method for making the device utilizing the apparatus made by the method of claim 82.

84. A method of making a wafer utilizing the apparatus made by the method of claim 82.
